(19) United States
(12) Patent Application Publication
(10) Pub. No.: US 2024/0123775 A1
(43) Pub. Date: Apr. 18, 2024

(54) TIRE MONITORING APPARATUS, SYSTEM, AND METHODS

(71) Applicant: Consolidated Metco, Inc., Vancouver, WA (US)

(72) Inventors: Michael Robinett, Battle Ground, WA (US); Stephen McGarry, Vancouver, WA (US); Jeremiah Eriksen, Beaverton, OR (US); Natalie Clouse, Vancouver, WA (US); John Connell, Camas, WA (US); Brett Buchholtz, Washougal, WA (US)

(21) Appl. No.: 18/380,075

(22) Filed: Oct. 13, 2023

Related U.S. Application Data
(60) Provisional application No. 63/415,816, filed on Oct. 13, 2022.

(51) Int. Cl. B60C 23/04

(52) U.S. Cl. CPC B60C 23/0496; B60C 23/041; B60C 23/0433

(57) ABSTRACT

In one aspect, a tire monitoring apparatus having a circuit board, battery, and valve body intermediate the circuit board and the battery. The valve body has an attachment end portion for connecting to a valve stem of a tire, a filling end portion, and an internal passageway to permit air to travel from the filling end portion to the attachment end portion. The circuit board has a sensor configured to detect a variable of air traveling in the internal passageway of the valve body and communication circuitry of the circuit board operable to wirelessly communicate data associated with the variable of the air. The tire monitoring apparatus further includes a support permanently encapsulating the circuit board and battery about the valve body. The support includes a structural member molded onto the valve body and an embedding member securing the circuit board and the battery to the structural member.

### CROSS-REFERENCE TO RELATED APPLICATION

This application claims benefit of U.S. Provisional Application No. 63/415,816, filed on Oct. 13, 2022, which is hereby incorporated herein by reference in its entirety.

### FIELD

This disclosure relates to vehicle monitoring systems and, in particular, to tire monitoring systems for vehicles.

### BACKGROUND

Organizations strive to maintain commercial vehicles to minimize downtime of these vehicles, particularly, roadside breakdowns. Tires are one aspect of the commercial vehicle that are often in need of maintenance. Driving the commercial vehicle with a tire that is improperly inflated may result in increased wear to the tire, a roadside breakdown, and/or decreased fuel economy.

Some companies have developed systems for monitoring and reporting the pressure of the tire; however, these existing systems have shortcomings. For example, some valve stem-mounted tire pressure sensors are bulky and only able to be used in specific vehicle applications that provide sufficient clearance to fit the tire pressure sensor. Moreover, these bulky tire pressure sensors are prone to contacting the wheel during use which may damage the tire pressure sensor. Additionally, some valve stem-mounted tire pressure sensors may damage the valve stem due to fatigue loading of the valve stem caused by the weight of the tire pressure sensor. Still further, some tire pressure sensors are prone to unthreading from the valve stem resulting in air leaking from the tire.

### SUMMARY

In one aspect of the present disclosure, a tire monitoring apparatus is provided that includes a circuit board, a battery, and a valve body intermediate the circuit board and the battery. The valve body has an attachment end portion for connecting to a valve stem of a tire, a filling end portion for receiving pressurized air, and an internal passageway to permit air to travel from the filling end portion to the attachment end portion. The circuit board has a sensor configured to detect a variable of air in the internal passageway of the valve body and communication circuitry of the circuit board operable to wirelessly communicate data associated with the variable of the air. The tire monitoring apparatus further includes a support permanently encapsulating the circuit board and the battery about the valve body. The support protects the circuit board and battery from the ingress of liquid and debris, which improves the durability of the tire monitoring apparatus. The support includes a structural member molded onto the valve body and an embedding member securing the circuit board and the battery to the structural member. Molding the structural member onto the valve body permits the structural member to closely conform to the geometry of the valve body and forms a rigid connection therebetween.

The present disclosure also provides a method of manufacturing a tire monitoring apparatus. The method includes molding a first material onto a valve body to form a first portion of a support and positioning a battery and a circuit board proximate the first portion of the support on opposite sides of the valve body. The circuit board includes a sensor to detect a variable of air in the valve body. The method further includes advancing a second material into contact with the first portion of the support to form a second portion of the support connected to the first portion of the support. The first and second portions of the support secure the battery and the circuit board to the valve body. The first portion of the support may operate as a structure to support the battery and circuit board and the second portion of the support secures the battery and circuit board to the first portion of the support.

In another aspect, the present disclosure provides a tire monitoring apparatus including a metallic fitting having threads to engage threads of a valve stem of a tire. The tire monitoring apparatus further includes a circuit board having a sensor with a sensing portion configured to detect a variable of air received via a through opening in the metallic fitting. The tire monitoring apparatus has a sealing member between the circuit board and the metallic fitting, the sealing member forming a seal about the sensing portion of the sensor. The tire monitoring apparatus further includes a support connecting the circuit board to the metallic fitting. The support maintains the circuit board at a predetermined distance from the metallic fitting to compress the sealing member and maintain the seal. In this manner, the circuit board operates as both a sensor to detect a variable of air in the metallic fitting and maintains a compressive load against the sealing member to keep the sealing member sealingly engaged with the adjacent surfaces.

The present disclosure further provides a tire monitoring apparatus including a valve body having a central, longitudinal axis. The valve body has an attachment end portion of the valve body configured to be engaged with a valve stem of a tire and a filling end portion of the valve body configured to receive compressed air. The tire monitoring apparatus has a central body connected to the valve body and including a sensor to detect a variable of air in the valve body, a battery, and communication circuitry operable to wirelessly communicate data associated with the variable. The attachment end portion of the valve body has an actuator with a central portion intersected by the central, longitudinal axis and configured to open a valve of the valve stem upon the attachment end portion being connected to the valve stem. The actuator further includes three axial through openings of the actuator radially offset from the central, longitudinal axis and spaced thereabout to permit air to pass through the actuator. The actuator further includes three spoke portions of the actuator defined at least in part by the three axial through openings of the actuator and supporting the central portion of the actuator in the attachment end portion of the valve body. The three axial through openings provide a large open area of the actuator to minimize pressure drop across the actuator, which reduces airflow restriction and reduces the time required to fill the tire to a desired internal air pressure. Further, the three spoke portions provide a rigid support for the central portion of the actuator to facilitate the central portion of the actuator shifting a pin of a valve of a valve stem to open the valve.

### BRIEF DESCRIPTION OF THE DRAWINGS

FIG. 1A is a rear, top perspective view of a tire monitoring apparatus.

FIG. 1B is a front, bottom perspective view of the tire monitoring apparatus of FIG. 1A.

FIG. 2 is an exploded view of the tire monitoring apparatus of FIG. 1A.

FIG. 3A is a cross-sectional view of the tire monitoring apparatus of FIG. 1A taken along line 3A-3A of FIG. 1A.

FIG. 3B is a cross-sectional view of the tire monitoring apparatus of FIG. 1A taken along line 3B-3B of FIG. 1A.

FIG. 3C is a partial cutaway view of the tire monitoring apparatus of FIG. 1A.

FIG. 3D is a cross-sectional view of the tire monitoring apparatus of FIG. 1A taken along line 3D-3D of FIG. 1A.

FIG. 4A is a top perspective view of an inner structure and a cap of the tire monitoring apparatus of FIG. 1A.

FIG. 4B is a bottom perspective view of the inner structure and cap of FIG. 4A.

FIG. 5A is a bottom perspective view of a seal of the tire monitoring apparatus of FIG. 1A.

FIG. 5B is a top perspective view of the seal of FIG. 5A.

FIG. 6A is a top perspective view of a circuit board of the tire monitoring apparatus of FIG. 1.

FIG. 6B is a bottom perspective view of the circuit board of FIG. 6A.

FIG. 7 is a block diagram of a tire pressure monitoring system including the monitoring apparatus of FIG. 1A, a server computer, and an onboard computing device.

FIG. 8A is a top perspective view of a tire monitoring apparatus according to another embodiment.

FIG. 8B is a bottom perspective view of the tire monitoring apparatus of FIG. 8A.

FIG. 9 is a cross-section view of the tire monitoring apparatus of FIG. 8A taken along line 9-9 of FIG. 8A.

FIG. 10 is an exploded view of the tire monitoring apparatus of FIG. 8A.

FIG. 11 is a perspective view of a tire monitoring apparatus according to another embodiment.

FIG. 12 is an exploded view of the tire monitoring apparatus of FIG. 11 with internal potting of the tire monitoring apparatus removed for clarity.

FIG. 13A is a cross-sectional view of the tire monitoring apparatus of FIG. 11 taken along line 13A-13A of FIG. 11.

FIG. 13B is a cross-sectional view of the tire monitoring apparatus of FIG. 11 taken along line 13B-13B of FIG. 11.

FIG. 13C is a cross-sectional view of the tire monitoring apparatus of FIG. 11 taken along line 13C-13C of FIG. 11.

FIG. 13D is a cross-sectional view of the tire monitoring apparatus of FIG. 11 taken along line 13D-13D of FIG. 11.

FIG. 14A is a bottom perspective view of a housing and a valve body of the tire monitoring apparatus of FIG. 11.

FIG. 14B is a top perspective view of the housing and valve body of FIG. 14A.

FIG. 15A is a bottom perspective view of the valve body of the tire monitoring apparatus of FIG. 11.

FIG. 15B is an end elevational view of the valve body of the tire monitoring apparatus of FIG. 11.

FIG. 16A-16D are cross-sectional views of the housing and valve body of the tire pressure monitoring apparatus of FIG. 11 taken similar to FIG. 13C, FIGS. 16A-16D illustrating installation of a circuit board into the housing.

FIG. 17A is a bottom perspective view of the housing and valve body of the tire pressure monitoring apparatus of FIG. 11 with the circuit board installed, FIG. 17A illustrating attachment of an end cap to the housing.

FIG. 17B is a top perspective view of the housing and valve body of the tire pressure monitoring apparatus of FIG. 11, FIG. 17B illustrating attachment of a battery and end cap to the housing.

### DETAILED DESCRIPTION

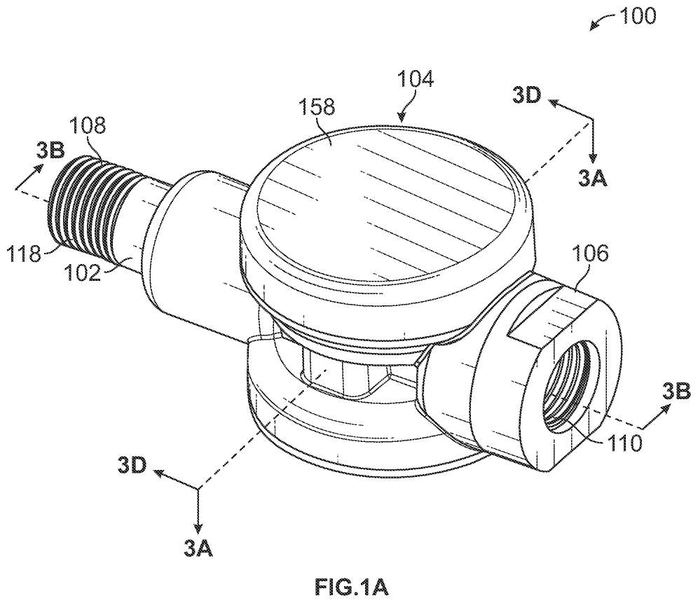

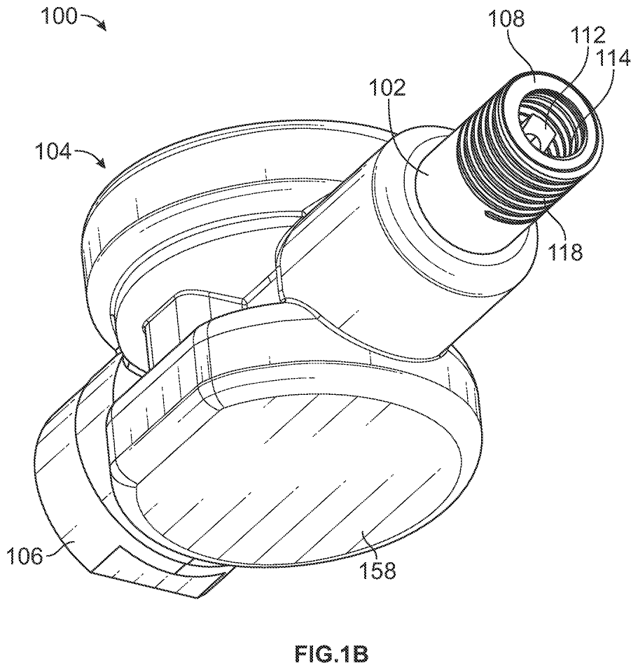

With respect to FIGS. 1A-3D, a monitoring apparatus 100 is provided for monitoring one or more variables of a tire of a vehicle. The vehicle may be a commercial vehicle such as a tractor, a trailer, a box truck, or a bus as some examples. The vehicle may also be a passenger vehicle such as a car, SUV, or a pickup truck as some other examples.

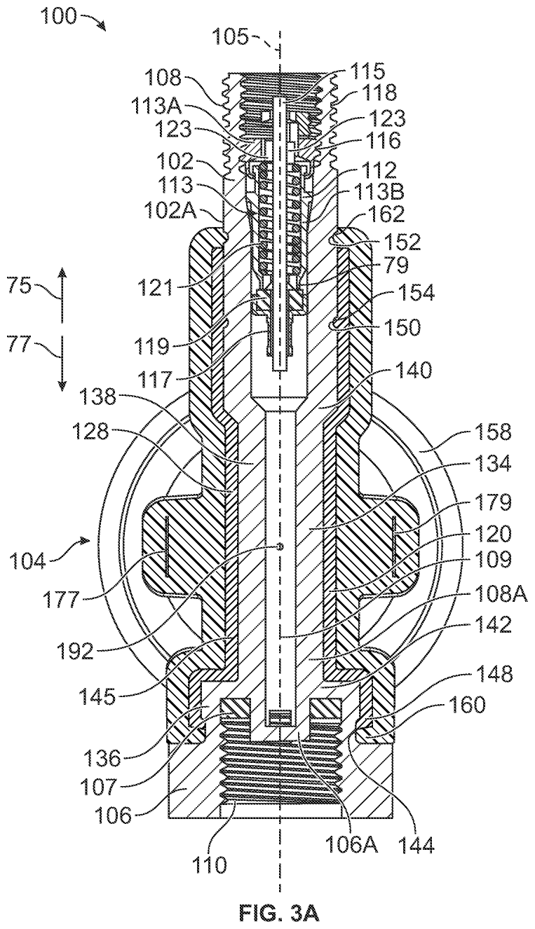

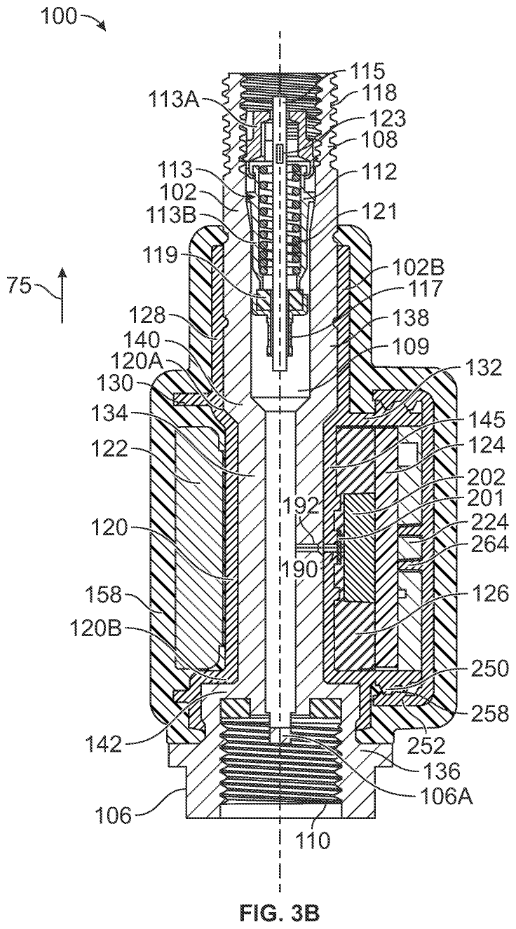

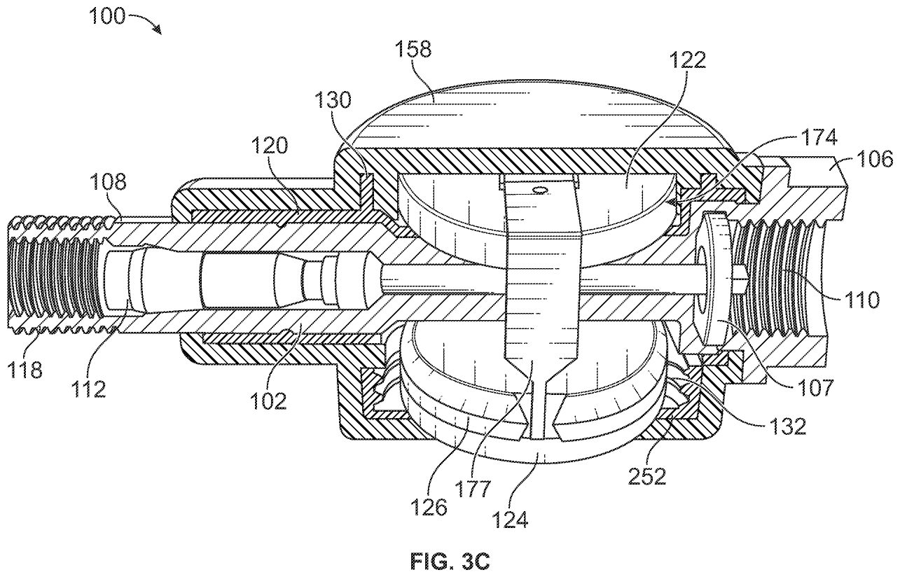

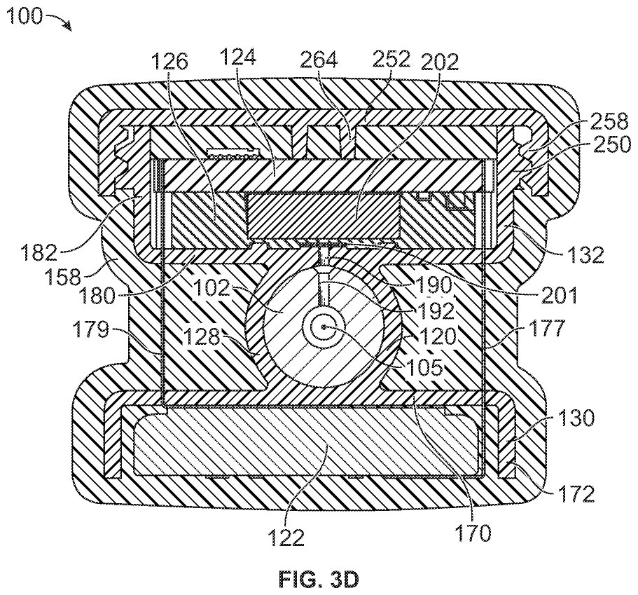

The monitoring apparatus 100 includes a core or fitting, such as valve body 102, that extends through a central body 104. The valve body 102 has an attachment end portion 106 with threads to connect to a valve stem of a tire and a filling end portion 108, which may be threaded, for connecting to a pressurized air source. One or more components of the valve body 102 may be made of a metallic material, for example, brass. With reference to FIG. 3A, the valve body 102 includes a tubular sidewall 102A extending about a central axis 105 and forming a flow path or passageway 109 extending from the attachment end portion 106 to the filling end portion 108. The center of mass of the monitoring apparatus 100 may be aligned with the central axis of the valve body 102 to inhibit turning of the monitoring apparatus 100 when mounted to a valve stem, as discussed in further detail below. The attachment end portion 106 of the valve body 102 includes a core actuator or pin 106A that shifts the pin of a Schrader valve of a valve stem of a tire from a closed position to an open position when the monitoring apparatus 100 is connected to the valve stem. Thus, attaching the monitoring apparatus 100 to the valve stem of the tire opens the valve of the valve stem and permits air to flow from the tire into the monitoring apparatus 100. Conversely, when pressurized air is applied to the filling end portion 108, the pressurized air may travel through the valve body 102 and into the tire. The monitoring apparatus 100 is thus placed in fluid communication with the interior volume of the tire to monitor one or more variables (e.g., tire pressure, temperature, humidity, or a combination thereof) of the tire as described in further detail below. The monitoring apparatus 100 may include a seal 107 (e.g., an O-ring) positioned in the attachment end portion 106 of the valve body 102 that the valve stem contacts when threaded to the attachment end portion 106 to create a fluid tight connection between the valve stem and the valve body 102.

The filling end portion 108 may operate similarly to the end of a valve stem of a tire. For example, an air chuck may be connected to the filling end portion 108 to force air through the passageway 109 of the valve body 102 of the monitoring apparatus 100 and out of the attachment end portion 106 into the tire. The diameter of the passageway 109 may be larger than in some conventional tire pressure monitoring devices to reduce restriction of the airflow such that the tire may be filled more quickly. The filling end portion 108 may include a valve core 112 that operates as a one-way valve to inhibit air from flowing out of the tire through the monitoring apparatus 100 while permitting the tire to be filled via pressurized air applied to the filling end portion 108. The valve core 112 may include, for example, a Schrader valve core. The filling end portion 108 may include internal threads 114 that engage the external threads 116 of the valve core 112 to fix the valve core 112 in the filling end portion 108 of the valve body 102.

With reference to FIG. 3A, the valve core 112 includes a housing 113 having a first portion 113A including the external threads 116 and a second portion 113B. The valve core 112 has a pin 115 extending through a center of the housing 113. A valve head 117 including a sealing member 119 (e.g., an elastomeric washer) is coupled to the pin 115. The valve core 112 includes a biasing member, such as spring 121, that engages protrusions, such as tabs 123, of the pin 115 to bias the pin 115 and sealing member 119 coupled thereto in direction 75 to seat the sealing member 119 against a rim 79 of the second portion 113B of the housing 113. To open the valve core 112, the pin 115 is urged in direction 77 along axis 105 against the bias force of the spring 121 to unseat the sealing member 119 from the rim 79 of the housing 113. For example, the air chuck used to provide air to the filling end portion 108 may have a surface that engages the protruding end of the pin 115 to shift the pin 115 and sealing member 119 in direction 77 when the air chuck is connected to the filling end portion 108. Pressurized air may flow through the valve core 112 generally in direction 77 once the sealing member 119 has been shifted in direction 77 away from the rim 79 of the housing 113.

When the air chuck is disconnected from the filling end portion 108, the spring 121 biases the pin 115 and sealing member 119 along the axis 105 in direction 75 to seat the sealing member 119 against the rim 79 of the housing 113 thus inhibiting air from flowing into or out of the valve core 112. The filling end portion 108 of the valve body 102 may further include external threads 118 to which a cap may be threaded to close the filling end portion 108 of the valve body 102.

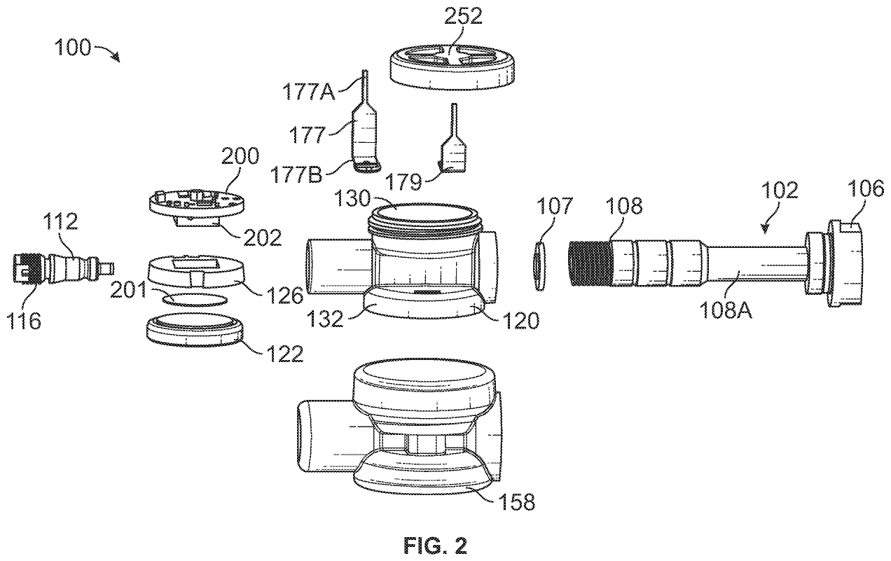

With reference to FIGS. 1B and 2, the central body 104 of the monitoring apparatus 100 includes an inner support 120 and an outer body 158 that together contain the internal components of the monitoring apparatus 100 including a power source such as a battery 122, a circuit board 124, and a seal 126. The inner support 120 includes a central tubular portion 128, a first tray portion 130, and a second tray portion 132. The inner support 120 may be formed of a plastic that is durable and dimensionally stable across the operating pressure and temperature ranges of the monitoring apparatus 100 (e.g., nylon, glass filled nylon) and molded over the valve body 102 to attach the inner support 120 to the valve body 102. For example, the inner support 120 may be insert-molded over the valve body 102 such that the valve body 102 extends through the central tubular portion 128. The valve body 102 may include a narrowed portion 134 having an outer diameter with an outer diameter that is smaller than the outer diameters of enlarged portions 136, 138 of the valve body 102 on either end of the narrowed portion 134. The valve body 102 has a tapered or frustoconical portion 140 flaring outwardly from the narrowed portion 134 to the enlarged portion 138 and a step or shoulder portion 142 extending outwardly from the narrowed portion 134 to the enlarged portion 136. The engagement between the frustoconical portion 140, shoulder portion 142, and surfaces 120A, 120B of the inner support inhibit relative axial movement of the valve body 102 and the inner support 120. For example, by molding the central tubular portion 128 over the frustoconical and shoulder portions 140, 142 and the narrowed portion 134, the central tubular portion 128 of the inner support 120 likewise includes a collar portion 145 that is not able to pass over the frustoconical and shoulder portions 140, 142 thus inhibiting the inner support 120 from sliding axially along the valve body 102 during operation of the vehicle.

With reference to FIG. 3A, the enlarged portion 136 of the valve body 102 at the attachment end portion 106 may include an annular recess 144 that an annular protrusion 148 of the central tubular portion 128 of the inner support 120 extends into to aid in securing the inner support 120 to the valve body 102 and inhibiting the inner support 120 from moving axially relative to the valve body 102. The end portion 138 of the valve body 102 at the filling end portion 108 may include annular recesses 150, 152. An annular protrusion 154 of the central tubular portion 128 of the inner support 120 extends into the annular recess 150 to aid in securing the inner support 120 to the valve body 102. The annular protrusions 148, 154 of the inner support 120 may be formed when the inner support 120 is molded over the annular recesses 144, 150 of the valve body 102. The outer body 158 may be molded over the inner support 120 and internal components once assembled as discussed below. The outer body 158 may be molded over the annular recess 144 at the enlarged portion 136 of the valve body 102 and the annular recess 152 of the end portion 138 such that annular protrusions 160, 162 of the outer body 158 extend into the recesses 144, 152 securing the outer body 158 to the valve body 102. Including the annular recesses and protrusions may aid in inhibiting fluid and debris from entering the central body 104, for example, by travelling along the outside surface of the valve body 102.

The valve body 102 may further include protrusions and/or recesses on an outer surface 102B thereof that the inner support 120 engages to inhibit the inner support 120 from turning relative to the valve body 102 during rotation of the associated wheel. As one example, the valve body 102 may include knurling on the narrowed portion 134, enlarged portion 136, and/or enlarged portion 138. When the inner support 120 is molded over the valve body 102, the plastic of the inner support 120 extends into the recesses of the valve body 102 and/or forms a recess over a protrusion of the valve body 102 which aids in resisting rotation relative to the valve body 102. As another example, the valve body 102 may include ribs that extend longitudinally along the valve body 102 that the inner support 120 is molded over to inhibit the inner support 120 from rotating relative to the valve body 102. As another example, the valve body 102 may have flats on the outside surface 102B of the valve body 102 such that at least a portion of the valve body 102 has a non-circular cross-section, such as a polygonal or D-shaped cross-section. With a non-circular cross-section, the inner support 120 keys to the valve body 102 and is inhibited from rotating relative to the valve body 102.

With reference to FIGS. 3A-3D, the inner support 120 supports the internal components of the monitoring apparatus 100 in the first tray portion 130 and second tray portion 132 on opposite sides of the valve body 102 and maintains the relative positioning of the components. For example, the battery 122 is in the first tray portion 130 and the seal 126 and circuit board 124 are in the second tray portion 132. By supporting the components on opposite sides of the valve body 102 with the inner support 120, the center of mass of the central body 104 may be coaxial with the central axis 105 of the valve body 102 (see FIG. 3D). The radial position of the first tray portion 130 and second tray portion 132 may be adjusted based on the weight and shape of the battery 122, seal 126, and/or circuit board 124 to align the center of mass of the central body 104 with the valve body 102.

Balancing the weight of the internal components substantially evenly about the valve body 102 is advantageous in inhibiting the monitoring apparatus 100 from unthreading from the valve stem. For example, some conventional tire pressure monitoring devices have all of the internal components mounted on one side of the device which results in a weight imbalance in the device. The weight imbalance of these conventional device may result in the tire pressure monitoring device unthreading (at least partially) from the valve stem which may cause air to leak from the tire. For example, as the tire rotates, the mass of the device tends to move radially outward due to inertia. Where the weight of the device is imbalanced (e.g., not aligned with the valve stem of the tire), the heavier side of the device may have a greater radially outward force creating a torque about the valve stem and causing the device to partially unthread. The monitoring apparatus 100 addresses this problem by distributing the weight of the monitoring apparatus 100 substantially evenly about the valve body 102.

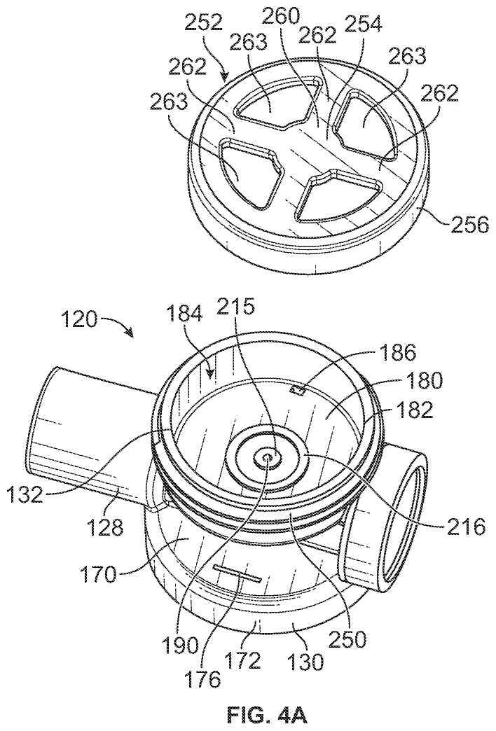

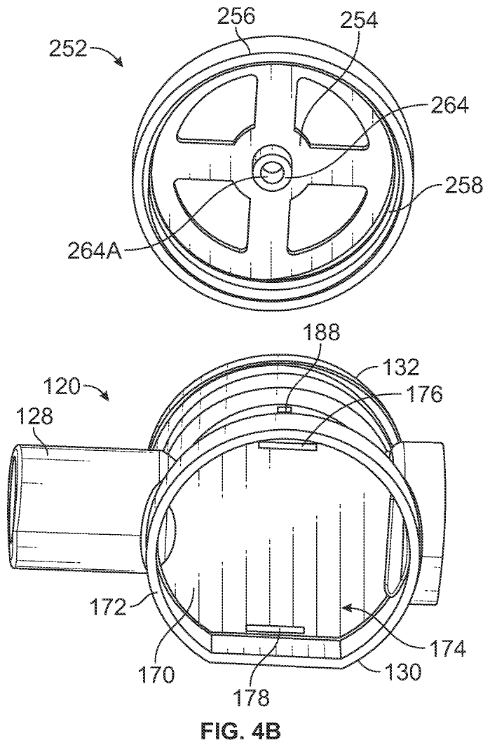

With respect to FIG. 4A-4B, the first tray portion 130 of the inner support 120 includes a base 170 and a sidewall 172 extending from the base 170. The base 170 and sidewall 172 form a recess 174 for receiving the battery 122 (see FIG. 3B). The base 170 includes slots 176, 178 through which terminals 177, 179 may extend from the battery 122 to the second tray portion 132 of the inner support 120. A first end portion 177A of the terminals 177, 179 may be connected to the positive and negative sides of the battery 122 and a second end portion 177B of the terminals 177, 179 may be connected, such as soldered, to the circuit board 124. The terminals 177, 179 made of a conductive material (e.g., aluminum, copper) to conduct electrical power from the battery 122 to the circuit board 124. The outer body 158 may be molded over the battery 122 and the first tray portion 130 to secure the battery 122 in the first tray portion 130. The outer body 158 may at least partially encapsulate the battery 122 and the first tray portion 130 to form a fluid tight seal to inhibit fluid from entering the first tray portion 130.

The second tray portion 132 of the inner support 120 is opposite the central tubular portion 128 from the first tray portion 130. The second tray portion 132 includes a base 180 and a sidewall 182 extending from the base 180. The base 180 and sidewall 182 form a recess 184 for receiving the seal 126 and the circuit board 124. The base 180 includes slots 186, 188 through which the terminals 177, 179 extend from the battery 122 in the first tray portion 130 and over the valve body 102 to the circuit board 124 (see FIGS. 3A and 3C). The base 180 of the second tray portion 132 includes an opening 190 that extends through the central tubular portion 128 to the valve body 102. The valve body 102 also includes an opening 192 (see FIG. 3B) in the sidewall 108A that is aligned with the opening 190 of the inner support 120. Air is thus able to flow from the passageway 109 (see FIG. 3B) of the valve body 102, through the opening 192 of the valve body 102, through the opening 190 of the inner support to the second tray portion 132.

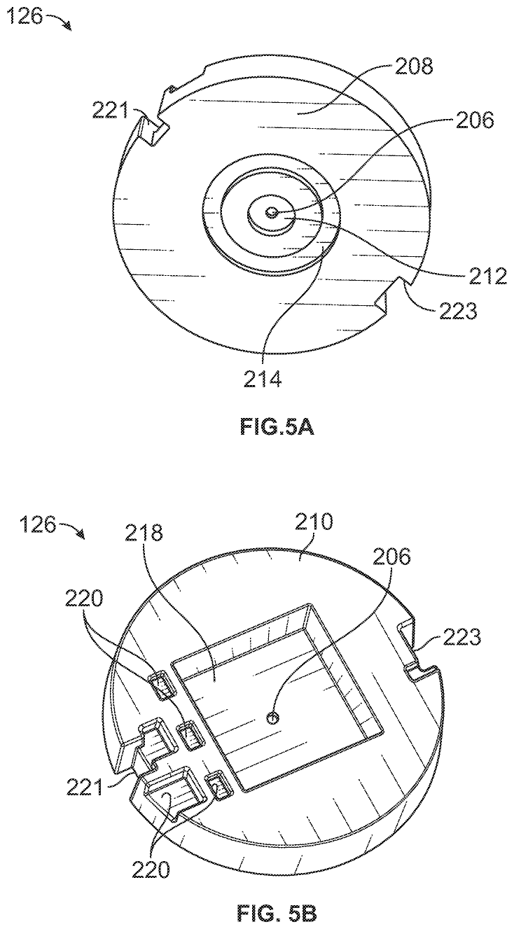

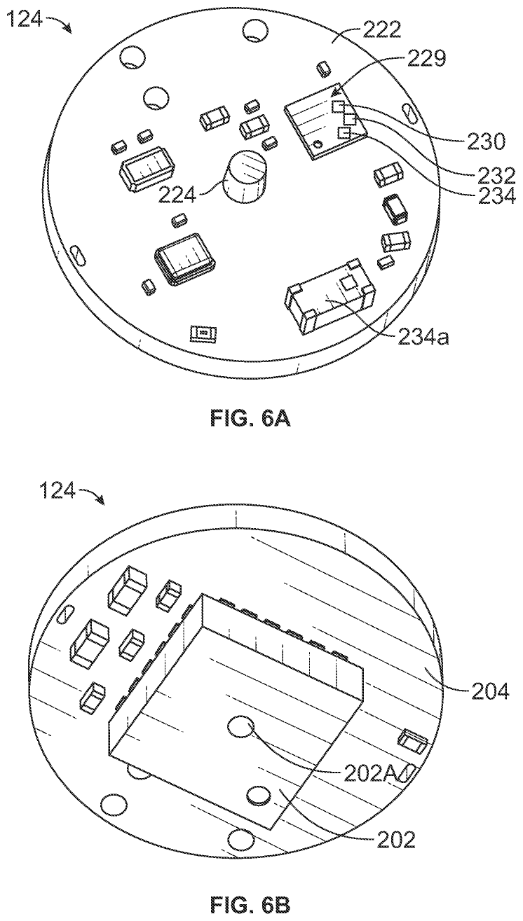

With respect to FIGS. 3B-3C, the seal 126 and the circuit board 124 are positioned in the recess 184 of the second tray portion 132. The circuit board 124 includes a sensor 202 for collecting data to monitor a condition of the tire. The sensor 202 may include, for example, a pressure sensor and/or a temperature sensor, to monitor the pressure and/or temperature of the air of the tire. The sensor 202 may be mounted to a first side 204 (see FIG. 6B) of the circuit board 124 facing the base 180 of the second tray portion 132. The seal 126 is sandwiched between the circuit board 124 and the base 180 of the second tray portion 132. The seal 126 includes a through opening 206 (see FIGS. 5A-5B) that fluidly connects a port 202A of the sensor 202 (see FIG. 6B) to the opening 190 of the inner support 120 and thus the valve body 102. A barrier such as membrane 201 may be positioned between the seal 126 and the base 180 of the second tray portion 132 to cover the opening 190 of the inner support 120 and inhibit water from passing into the second tray portion 132. The membrane 201 may be permeable to air and impermeable to liquids (e.g., water). In one embodiment, the membrane 201 is a semi-permeable membrane made of a porous polytetrafluoroethylene (PTFE), for example, a Gore-Tex™. PTFE membrane. The membrane 201 inhibits liquids, such as water in the valve body 102, from reaching the sensor 202 which could interrupt the sensor readings and/or damage the sensor 202. For example, liquid may be blown into the valve body 102 when the valve body 102 is used to fill the tire with air. For instance, water in an air compressor or snow/water in the filling end portion 108 of the valve body 102 (e.g., from rain or snowmelt) may be blown into the passageway 109 of the valve body 102 when compressed air is applied to the filling end portion 108. The seal 126 encircles the opening 190 and forms a fluid tight seal with the base 180 of the second tray portion 132 and the first side 204 of the circuit board 124 to inhibit air from flowing radially outward beyond a recess 212 (see FIG. 5A) on the underside of the seal 126. In other words, the seal 126 limits the pressurized air of the tire to traveling in the opening 206 and contacting the sensor 202 and inhibits the pressurized air from escaping into the remainder of the recess 184 of the second tray portion 132.

With respect to FIGS. 5A-5B, the seal 126 includes may be a pad sized to be inserted in the second tray portion 132 of the inner support. The seal 126 may be made of an elastomeric thermoset material, for example, silicone, polyurethane, nitrile, and/or ethylene propylene diene monomer (EPDM) rubber. The seal 126 includes a first side 208 for contacting and sealing against the base 180 of the second tray portion 132 and a second side 210 for contacting and sealing against the circuit board 124. The first side 208 of the seal 126 includes a recess 212 about the opening 206 and an annular recess 214 concentric about the recess 212 for receiving a protrusion 215 (see FIG. 4A) and annular protrusion 216, respectively, of the base 180 of the second tray portion 132 of the inner support 120. The mating of the protrusions 215, 216 of the second tray portion 132 with the recesses 212, 214 of the seal 126 may aid in ensuring that the seal 126 is positioned such that the opening 206 of the seal 126 is aligned with the opening 190 of the inner support 120. The mating engagement of the protrusions 215, 216 in the recesses 212, 214 may further aid to hold the seal 126 in position when the outer body 158 is molded over the inner support 120 and seal 126.

Regarding FIG. 5B, the second side 210 of the seal 126 includes a recess 218 about the opening 206 in the seal 126 for receiving the sensor 202 of the circuit board 124. The second side 210 of the seal 126 forms a seal surface that contacts and seals against the sensor 202 around the sensor port 202A (see FIG. 6B) and/or the circuit board 124 to inhibit air from passing between the seal 126 and the circuit board 124. The second side 210 of the seal 126 may further include recesses 220 for receiving other components mounted to the first side 204 of the circuit board 124 to ensure the second side 210 of the seal 126 is in contact with the circuit board 124 to form a seal therebetween. The seal 126 may include recesses or notches 221, 223 which the terminals 177, 179 extend through to connect the circuit board 124 and the battery 122.

With respect to FIGS. 6A-6B, the sensor port 202A of the sensor 202 is positioned over the opening 206 of the seal 126 to collect data. The sensor 202 may include a pressure sensor that measures the pressure of the air of the tire. Additionally or alternatively, the sensor 202 may include a temperature sensor to measure the temperature of the air of the tire.

Regarding FIG. 6A, the circuit board 124 further may have a chip 229 including a processor 230, memory 232, and communication circuitry 234 which may be mounted to a second side 222 of the circuit board 124. Additionally or alternatively, the sensor 202 may also include a processor and memory. The processor 230 of the chip 229 and the processor of the sensor 202 may be in communication with one another. The processor 230 of the chip 229 and/or the processor of the sensor 202 may monitor the condition of the tire and operate the communication circuitry 234 to communicate a signal to one or more remote computing devices such as an onboard computing device 240 and/or a remote server computer 270 as described in further detail below. The communication circuitry 234 may include a surface-mount chip antenna 234A. Some conventional tire pressure monitoring devices include a large wire-form antenna because the battery is mounted directly on the printed circuit board and would block the signal from a surface mount antenna. These wire-form antennas extend to a position where the signal is able to be communicated without the battery blocking the signal. In the monitoring apparatus 100, the surface-mount chip antenna 234A is able to be used because the battery 122 is spaced apart from the chip antenna 234A and is on the other side of the valve body 102 which limits signal interference experienced by the chip antenna 234A due to the battery 122. The chip antenna 234A is significantly smaller and more compact than conventional wire-form antennas resulting in the monitoring apparatus 100 being more compact and lighter weight.

With respect to FIG. 3B, the second tray portion 132 further includes threads 250 to which a cap 252 may be threaded to the end of the second tray portion 132 to secure the seal 126 and the circuit board 124 in the second tray portion 132. With reference to FIG. 4A, the cap 252 includes an end wall 254 and a sidewall 256 extending from the end wall 254. The sidewall 256 includes threads 258 (see FIG. 4B) to engage the threads 250 of the second tray portion 132. Prior to the outer body 158 being overmolded onto the inner support 120 and components supported therein, the cap 252 is threaded onto the second tray portion 132 to force the circuit board 124 toward the base 180 of the second tray portion 132 and against the seal 126. The cap 252 may thereby operate to clamp the seal 126 between the base 180 of the second tray portion 132 and the circuit board 124 which compresses the seal 126 to aid in forming and maintaining a fluid tight connection between the base 180 and the seal 126. With reference to FIG. 4A, in one embodiment the end wall 254 of the cap 252 includes a central hub 260 and spokes 262 extending from the hub 260 to the sidewall 256. When the outer body 158 is molded onto the inner support 120, the outer body 158 flows through openings 263 between the spokes 262 and into the second tray portion 132 to cover the seal 126 and circuit board 124. The fluid tight seal formed by the seal 126 inhibits the liquid outer body 158 being molded onto the inner support 120 from reaching the port 202A of the sensor 202 and/or the opening 190 of the second tray portion 132.

The end wall 254 of the cap 252 may include an annular wall 264 (see FIG. 4B) having a central recess 264A sized to receive a post 224 (see FIG. 6A) extending from the second side 222 of the circuit board 124. When the cap 252 is threaded to the second tray portion 132, the annular wall 264 is positioned to receive the post 224 of the circuit board 124. With the post 224 extending into the central recess 264A, the circuit board 124 is centered such that the sensor 202 is aligned with the opening 190 of the second tray portion 132 and thus in fluid communication with the passageway 109 of the valve body 102. The mating annular wall 264 and post 224 may also operate as a stand-off to space the electronics on the second side 222 of the circuit board 124 from the end wall 254 of the cap 252. For example, the post 224 has a height sized to keep the spokes 262 of the end wall 254 from contacting the electronics of the second side 222 of the circuit board 124 as the cap 252 is threaded to the second tray portion 132.

Once the cap 252 has been secured to the second tray portion 132, the outer body 158 may be overmolded over the inner support 120, battery 122, seal 126, circuit board 124, and cap 252. The outer body 158 may be formed using a low-pressure injection molding process. The outer body 158 may be made of a plastic material such as polyamides, co-polyesters, and/epoxy resins. The outer body 158 may be made of a lightweight material (e.g., compared to epoxy/polymers) which reduces the overall weight of the monitoring apparatus 100. Reducing the weight of the monitoring apparatus 100 is beneficial because the reduced weight reduces the fatigue loading (e.g., high cycle fatigue) of the valve stem of the tire caused by the weight of the monitoring apparatus 100 shifting, for example, as the tire rotates. The monitoring apparatus 100 may operate in a harsh environment being positioned on a tire of a vehicle. For example, the monitoring apparatus is exposed to the weather, mud, and debris as the vehicle is driven. For instance, the vehicle may be driven off paved roads, for example, on a construction site or junkyard where the monitoring apparatus 100 may be covered in mud, rocks, and other debris. The outer body 158 creates a protective shell about the internal components of the monitoring apparatus 100 that protects the internal components from damage and the ingress of fluid and debris which improves the durability of the monitoring apparatus 100.

In one embodiment, the monitoring apparatus 100 is able to be assembled without the use of mechanical fasteners (e.g., screws) via the threaded connection between the cap 252 and the inner support 120 and the overmolding of the outer body 158 on the inner support 120. The inner support 120 and outer body 158 hold the internal components in place even when the monitoring apparatus 100 is under pressure. The monitoring apparatus 100 is compact by having the battery 122 on the opposite side of the valve body 102 from the circuit board 124. Additionally, by having the battery 122 on the opposite side of the valve body 102 from the circuit board 124, a surface-mount chip antenna is able to be utilized on the second side 222 of the circuit board 124. The surface-mount chip antenna is significantly smaller than the larger wire-form antennas utilized by some conventional valve stem mounted tire pressure sensors. The compact monitoring apparatus 100 is advantageous because the clearance between the monitoring apparatus 100 and the wheel of the vehicle is increased making harmful, damaging contact between the monitoring apparatus 100 and the wheel less likely (e.g., as the monitoring apparatus vibrates as the wheel rotates). The compact monitoring apparatus 100 is also able to fit where some conventional, larger valve stem mounted tire pressure sensors are not able to fit due to their size. As a result of the smaller size, the monitoring apparatus 100 is able to be used in a wider range of vehicle applications.

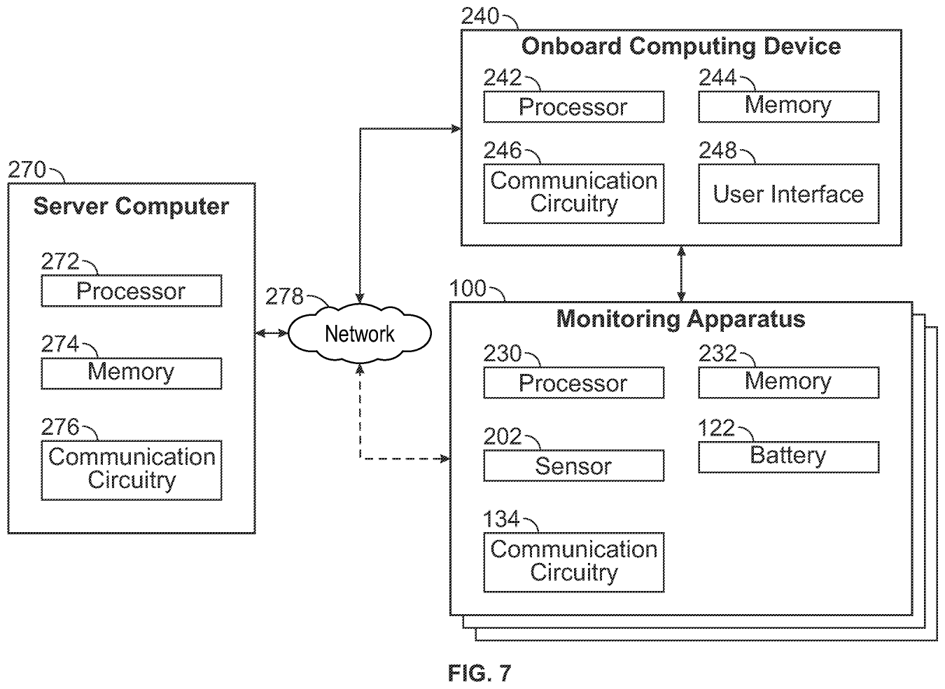

With respect to FIG. 7, the monitoring apparatus 100 may be used to monitor the condition of the tire and communicate a signal to one or more remote computing devices such as an onboard computing device 240 and/or a remote server computer 270. The processor 230 may be in communication with the memory 232, communication circuitry 234, and sensor 202. The processor 230 may access programs, data, and instructions stored in memory 232 to provide functionality for the monitoring apparatus 100. The processor 230 may communicate with the sensor 202 to collect sensor data (e.g., pressure and/or temperature data). In some forms, the sensor 202 is continuously powered and communicates sensor data to the processor 230 in substantially real time. In some forms, the processor 230 may turn the sensor 202 on periodically to collect sensor data periodically, for example, every fifteen to ninety seconds. Collecting sensor data periodically may conserve electrical power of the battery 122. In some forms, the processor 230 is able to determine when the monitoring apparatus 100 is mounted to a tire, for example, based on the pressure data. The processor 230 may operate in a sleep mode when the monitoring apparatus 100 is determined to not be connected to a tire where the processor 230 collects data less frequently (e.g., once every five minutes) to conserve the charge of the battery 122. Upon detecting a tire event, such as a pressure value indicating the monitoring apparatus 100 is connected to a tire, the processor 230 may operate in an active mode where data is collected more frequently (e.g., every twenty seconds). The processor 230 may cause the communication circuitry 234 to transmit sensor data without storing the sensor data in the memory 232, or the processor 230 may store sensor data for subsequent transmission or subsequent utilization by the processor 230 such as for historical data analysis. The processor 230 may be configured to wake from the sleep mode and check the pressure of the tire in response to various types of tire events, such as in an embodiment wherein the sensor 202 includes an accelerometer and a detected acceleration exceeds a predetermined threshold.

The processor 230 may operate the communication circuitry 234 to transmit and/or receive signals with the onboard computing device 240 and/or server computer 270. The communication circuitry 234 may be configured to communicate via radio frequency signals via one or more wireless protocols including as examples, Bluetooth, Zigbee, Z-wave, Wi-Fi, cellular or the like. In some forms, the communication circuitry 234 may be configured to communicate with the onboard computing device 240 and/or server computer 270 via a network 278 (e.g., a cellular network, an on-board vehicle communication network, and/or the Internet). The onboard computing device 240 may be a computing device of a vehicle (e.g., tractor or trailer) with which the monitored tire is associated. The onboard computing device 240 may be a gateway device through which the monitoring apparatus 100 communicates signals to the server computer 270. The onboard computing device 240 may be in communication with the server computer 270 and communicate information received locally from the monitoring apparatuses 100 of the vehicle to the server computer 270 and vice versa. In some forms, the monitoring apparatus 100 communicates with the server computer 270 over the network 278 rather than through the onboard computing device 240, such as in embodiments wherein the communication circuitry 234 includes a wide area wireless network interface such as a cellular network interface. The processor 230 may communicate with the onboard computing device 240 and/or server computer 270 via the communication circuitry 234, for example, to transmit the sensor data to the onboard computing device 240 and/or server computer 270. In some forms, the processor 230 may transmit the sensor data in substantially real time so that the onboard computing device 240 and/or server computer 270 is able to process the data and issue any alerts regarding a change in condition of the tire in real time. In another approach, the processor 230 may communicate a set of sensor data periodically, for example, communicate five to fifteen measurements every two to five minutes. In some forms, where the processor 230 determines that the data has not changed substantially over the time period, the processor 230 may send the most recent data, for example, the last measurement data. Communicating the data periodically may reduce the power consumed by the communication circuitry 234 to transmit the data, which conserves the charge of the battery 122.

In one embodiment, the server computer 270 analyzes data from the tire monitoring apparatus 100 and controls backend operations such as communicating data to a user device. In another embodiment, the processor 230 of the tire monitoring apparatus 100 may be configured to analyze, by itself or in conjunction with a remote device such as the onboard computing device 240, the sensor data, for example, to detect a current condition or a change in the condition of the tire. For example, the processor 230 may monitor the sensor data to determine whether the tire pressure is high or low, the tire is leaking air, the tire is flat (e.g., has blown out), the temperature of the tire is high, and/or the tire is in a good condition (e.g., pressure is stable within a desired pressure range). The memory 232 of the monitoring apparatus 100 may store datasets indicating acceptable ranges of pressures and temperatures for the tire. The memory 232 may also store programs for determining whether a change in tire pressure over time is indicative of a leak, for example, the memory 232 may store a threshold rate indicative that the tire is leaking air too quickly and is in need of maintenance (e.g., the tire has been punctured). The processor 230 may be configured to communicate the determined condition of the tire to the onboard computing device 240 and/or server computer 270. The processor 230 may be configured to communicate the determined condition to the onboard computing device 240 and/or server computer 270 periodically (e.g., once every two minutes) to conserve battery life. In some forms, upon determining a change in the condition of the tire (e.g., from a good condition), the processor 230 communicates the determined condition to the onboard computing device 240 and/or server computer 270 (e.g., immediately) without waiting for the next scheduled transmission to alert the remote device of the changed condition.

The onboard computing device 240 may include a processor 242, a memory 244, communication circuitry 246, and a user interface 248. The processor 242 communicates with the memory 244 and the communication circuitry 246 to receive and process signals from one or more monitoring apparatuses 100 of the vehicle. The processor 242 may receive signals from the monitoring apparatus 100 via the communication circuitry 246. The onboard computing device 240 may receive the sensor data from a monitoring apparatus 100 and process the data as described above to determine a condition of the tire. In some forms, where the monitoring apparatus 100 processes the sensor data, the onboard computing device 240 may receive the condition of the tire from the monitoring apparatus 100. The onboard computing device 240 may store the data received from the monitoring apparatus 100 in memory 244. The onboard computing device 240 may output the current condition of the tire(s) of the vehicle via the user interface 248. For example, when the monitoring apparatus 100, onboard computing device 240, and/or server computer 270 determines that the tire is not in a good condition (e.g., the tire is leaking, tire pressure is low), the onboard computing device 240 may output a notification via the user interface 248 to alert a user to the condition of the tire. The user interface 248 may include a human machine interface of the vehicle, such as the infotainment system of the vehicle. The user interface 248 may include a microphone, speaker, and/or display (e.g., touchscreen display, heads-up display, augmented reality display). In examples where the user interface 248 includes a display screen (e.g., a dashboard display of a vehicle), the onboard computing device 240 may present the condition to the user via the display screen. The user may further be able access or view the conditions of the tires using the user interface 248. For example, the user may navigate through an application of the infotainment center of the vehicle to cause the user interface 248 to output the conditions of the tires (e.g., via the speaker and/or display).

The server computer 270 may include a processor 272, memory 274, and communication circuitry 276. The processor 272 may be in communication with the memory 274 and communication circuitry 276. The server computer 270 may receive the sensor data and or tire condition from the monitoring apparatus 100 and/or onboard computing device 240 via the communication circuitry 276. The server computer 270 may store the information received from the monitoring apparatus 100 and/or onboard computing device 240 in memory 274. The server computer 270 may receive the sensor data and process the data as described above to determine a condition of the tire. The server computer 270 may be associated with an application (e.g., a smartphone application or website) which the driver may access to view the condition of the tire and/or the sensor data. For example, the user may open the application on their smartphone to view the current condition for each tire associated with the vehicle. The application may indicate when the maintenance should be performed on the tire, for example, when the tire pressure is low. The server computer 270 may communicate a notification to a user device (e.g., a smartphone, tablet computer, smartwatch, laptop computer) of the driver or fleet manager to notify the user of the condition of the tire. For example, the server computer 270 may send a push notification to the user device of the driver to be presented to the user. Where a fleet of vehicle is maintained by a maintenance team, the server computer 270 may send messages to a computing device of maintenance team indicating that a tire of the vehicle needs to be serviced. For example, the message may indicate which truck or trailer the tire is on, the location of the tire on the truck/trailer, and the maintenance condition of the tire. The maintenance team may then service the tire when the truck/trailer returns from the road and/or schedule maintenance of the truck/trailer. Where a tire is in need of roadside service (e.g., the tire is flat), the server computer 270 may request dispatch of a mechanic or other service personnel to the vehicle. The server computer 270 may receive the location of the vehicle from the onboard computing device 240 and request service from a service provider near the vehicle. The server computer 270 may send the location of the vehicle to and details regarding the condition of the tire to the service personnel.

The monitoring apparatus 100 may be assembled according to the following method. The inner support 120 may insert molded over the valve body 102 to secure the inner support 120 to the valve body 102. The inner support 120 is molded with the opening 190 aligned with the opening 192 of the valve body 102. The battery 122 may be positioned in the first tray portion 130. The terminals 177, 179 may be connected to the battery 122 and extended through the slots 176, 178 of the first tray portion 130 and through slots 186, 188 of the second tray portion 132. The membrane 201, seal 126 and circuit board 124 may be positioned in the second tray portion 132. The membrane 201 may be positioned to cover the opening 190 of the inner support 120. The seal 126 may be positioned with the opening 206 of the seal 126 aligned with the opening 190 of the inner support 120 to fluidly connect the sensor 202 of the circuit board 124 to the valve body 102. The ends of the terminals 177, 179 may be connected to the circuit board 124 to receive electrical power from the battery 122. The cap 252 may be threaded to the threads 250 of the second tray portion 132 of the inner support 120 to compress the seal 126 between the base 180 of the second tray portion 132 and the circuit board 124 to form a fluid tight connection. The outer body 158 may be molded over the assembled inner support 120, battery 122, seal 126, circuit board 124, and cap 252. The outer body 158 may be molded by a low-pressure injection molding process. The outer body 158 may encapsulate the inner support 120, battery 122, seal 126, circuit board 124, and cap 252 to inhibit fluid and debris from entering the monitoring apparatus 100.

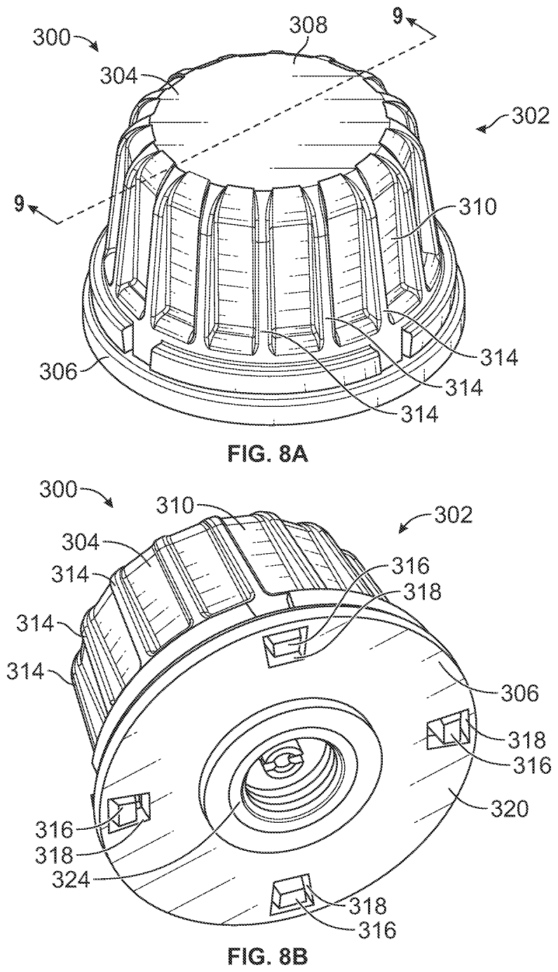

With respect to FIGS. 8A-10, a monitoring apparatus 300 is provided according to another embodiment. The monitoring apparatus 300 is similar in many respects to the monitoring apparatus 100 of FIG. 1A discussed above such that the differences will be highlighted. The monitoring apparatus 300 may replace the cap on a valve stem of a tire. The monitoring apparatus 300 may be removed from the valve stem to fill the tire.

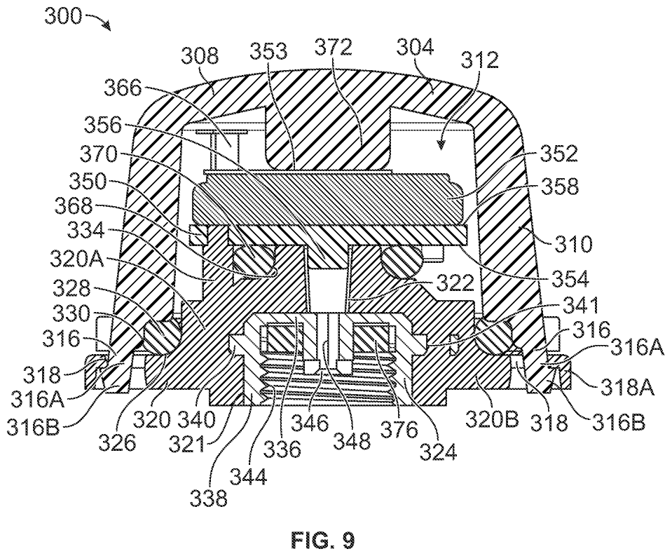

The monitoring apparatus 300 has a housing 302 including a cap 304 and a base 306. The cap 304 has an end wall 308 and a skirt or sidewall 310 extending from the end wall 308 forming a cavity 312. The sidewall 310 may include ribs 314 extending along the sidewall 310. The ribs 314 may provide the cap 304 with increased rigidity and strength. The ribs 314 may aid a user in gripping the sidewall 310 to thread or unthread the monitoring apparatus 300 to a valve stem of a tire. The cap 304 includes snap-fit protrusions 316 that extend from the end of the sidewall 310 to engage portions of the base 306 around the openings 318 to removably connect the cap 304 to the base 306. In one embodiment, the snap protrusions 316 each include a deflectable arm portion 316A and a barb portion 316B (see FIG. 9) that snap below and engage a lip 318A of the openings 318 of the base 306. The cap 304 may be formed of a plastic material, for example, glass filled or non-filled nylon and/or polycarbonate.

The base 306 includes a body 320 having a central portion 320A with a recess 321 and an opening 322 (see FIG. 9). The base 306 includes a fitting such as a valve cap 324 may be received in the recess 321 and aligned with the opening 322. The body 320 of the base 306 may be formed of a plastic material, for example, nylon or glass-filled nylon and the valve cap 324 may be machined or otherwise formed of a metallic material such as brass. The body 320 of the base 306 may be molded over the valve cap 324 such that the recess 321 is formed about the valve cap 324. The body 320 has a periphery 320B that includes the openings 318 which receive the snap protrusions 316 of the cap 304 to connect the cap 304 and the base 306. The periphery 320B of the body 320 may further include a seal engaging portion, such as an annular sealing surface portion 326, for supporting a seal 328 (e.g., an O-ring). The sidewall 310 of the cap 304 may include a seal engaging portion, such as an annular sealing surface portion 330, positioned to contact the seal 328. When the cap 304 is snap-fit to the base 306, the sealing surface portion 330 of the cap 304 contacts and compresses the seal 328 against the sealing surface portion 326 of the base 306 thus forming a fluid tight connection between the cap 304 and the base 306. In this manner, the seal 328 is sandwiched between the cap 304 and the body 320 of the base 306. The base 306 may include one or more posts 334 for supporting the circuit board 350.

Regarding FIG. 9, the valve cap 324 may have an end wall 336 and a sidewall 338 extending from the end wall 336. The sidewall 338 may include flange 340 extending radially from an outer surface of the sidewall 338. The flange 340 forms a mating engagement with a groove 341 of the body 320 to inhibit pull-out of the valve cap 324 from the body 320. The flange 340 may have one or more flat side surfaces to abut corresponding flat surfaces of the groove 341 and inhibit turning of the body 320 relative to the valve cap 324. In another embodiment, the flange 340 may include through openings and the body 320 includes portions extending in the through openings of the flange 340 and formed during molding of the body 320 to inhibit relative turning of the body 320 and the valve cap 324.

Regarding FIG. 9, the sidewall 388 of the valve cap 324 has an internal surface with threads 344 for engaging threads of a valve stem of a tire to connect the monitoring apparatus 300 to the valve stem. Similar to the attachment end portion 106 of the monitoring apparatus 100 of FIG. 1A, the valve cap 324 includes a core actuator or pin portion 346 that engages the pin of a Schrader valve of the valve stem and opens the Schrader valve when the monitoring apparatus 300 is attached to the valve stem. The end wall 336 of the valve cap 324 includes an opening 348 that extends through the pin portion 346 and is aligned with the opening 322 of the base 306. Thus, attaching the monitoring apparatus 300 to the valve stem of the tire opens the valve of the valve stem and permits air to flow from the tire, through the opening 348 of the valve cap 324, through the opening 322, and into contact with the sensor 356. The contact may be direct or indirect, such as in an embodiment wherein a water-impermeable membrane covers the sensor 356. The valve cap 324 may include a seal 376 (e.g., an O-ring) that the valve stem contacts when threaded to the valve cap 324 to create a fluid tight connection between the valve stem and the valve cap 324.

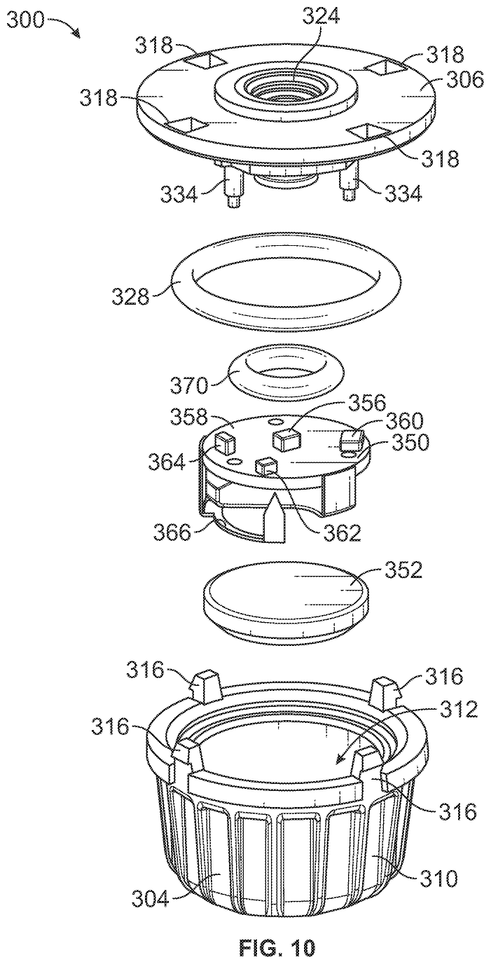

With reference to FIG. 10, the monitoring apparatus 300 further includes a circuit board 350 and a battery 352 electrically connected to and powering the circuit board 350. The circuit board 350 is similar to the circuit board 124 discussed above and may include the sensor 356 (e.g., pressure and/or temperature), a processor 360, a memory 362, and communication circuitry 364 including an antenna 366. In some forms, the sensor 356 is on a first side 354 (see FIG. 9) of the circuit board 350 and the processor 360, memory 362, and communication circuitry 364 are on a second side 358 of the circuit board 350. The circuit board 350 is mounted to the posts 334 or the base 306 with the first side 354 and sensor 356 facing the base 306. The sensor 356 may be aligned with and/or extending into the opening 322 of the base 306 to collect pressure and/or temperature data of the air of a tire. The processor 360 is in communication with the sensor 356, the memory 362 and, the communication circuitry 364 and may receive, analyze, and report the sensor data and/or related conditions to remote computing devices as described above.

Regarding FIG. 9, the base 306 includes a second seal engaging portion, such as a sealing surface portion 368, for engaging a seal 370 (e.g., an O-ring). The seal 370 may be sandwiched between the first side 354 of the circuit board 350 and the second sealing surface portion 368 to form a fluid tight connection therebetween. The seal 370 inhibits the air from the tire from passing into the remainder of the cavity 312 of the cap 304. In some forms, the processor 360, memory 362, and/or communication circuitry 364 are mounted to the first side 354 of the circuit board 350 radially outward of the seal 370. The battery 352 may be mounted on the second side 358 of the circuit board 350 and the cap 304 may include a protrusion 372 that presses against the battery 352 when the cap 304 is snapped onto the base 306. The protrusion 372 may urge the battery 352 against the circuit board 350 to compress the seal 370 between the circuit board 350 and the base 306 to aid in forming a fluid tight connection. Further, the compression of the battery 352 against the circuit board 350 may tightly engage the battery 352 with a battery terminal of the circuit board 350 and a battery terminal 353 on an opposite side of the circuit board 350. In this manner, the battery terminal 353, battery 352, and circuit board 350 may be stacked and held tightly between the protrusion 372 of the cap 304 and the central portion 320A of the base 306. The antenna 366 may be mounted to the circuit board 350 and extend from the circuit board 350 toward the end wall 308 of the cap 304 beyond the battery 352. By extending the antenna 366 around the battery 352, signals may be transmitted and/or received with limited interference from the battery 352.

The monitoring apparatus 300 may be assembled according to the following method. The base 306 may be molded over the valve cap 324, for example, by insert molding. The seals 328, 370 may be placed over the base 306 and positioned on their respective sealing surface portions 326, 368. The circuit board 350 and battery 352 may be mounted to the base 306 with the first side 354 of the circuit board 350 and the sensor 356 facing the base 306. The snap protrusions 316 of the cap 304 are aligned with the openings 318 of the periphery 320B of the base 306 and inserted into the openings 318. As the barb portions 316B of the snap protrusions 316 are inserted through the openings 318, the barb portions 316B cammingly engage the lip 318B of the respective opening 318 and shift radially inward which deflects the arm portions 316A. Once the barb portions 316B have advanced through the openings 318, the arm portions 316A resiliently unload and return to their original positions with flats on the undersides of the barb portions 316B engaging the lips 318A of the openings 318 of the base 306. As the cap 304 is snap-fit onto the base 306, the protrusion 374 of the end wall 308 of the cap 304 engages the battery terminal 353 and urges the battery 352 toward the base 306 and compresses the seal 370 between the circuit board 350 and the base 306. The cap 304 also contacts and compresses the seal 328 between the base 306 and the cap 304.

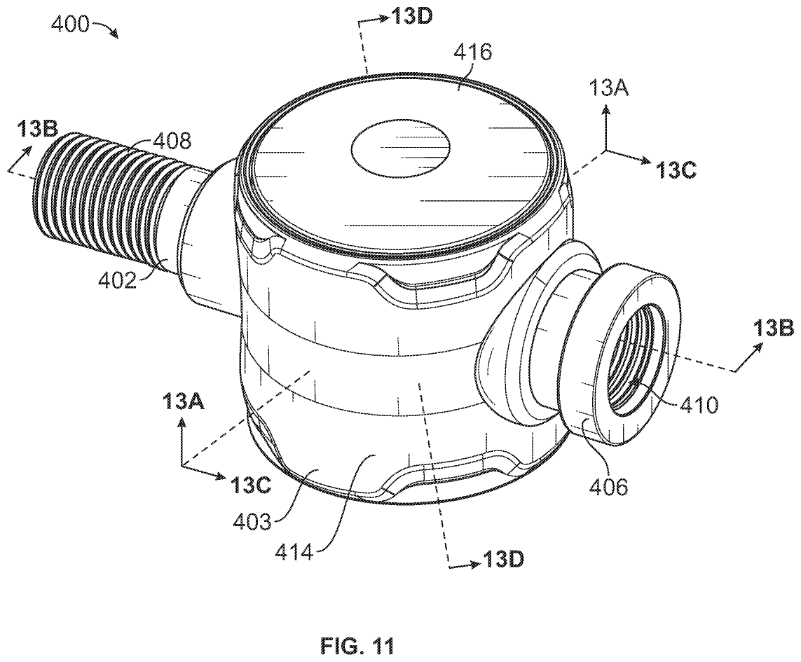

With respect to FIG. 11, a tire monitoring apparatus 400 is provided according to another embodiment. The tire monitoring apparatus 400 is similar in many respects to the monitoring apparatus 100 of FIG. 1A discussed above such that the differences will be highlighted. The tire monitoring apparatus 400 is attachable to a valve stem of a tire of a vehicle to monitor a condition of the tire (e.g., the air temperature, air pressure, air humidity). The tire monitoring apparatus 400 permits the tire to be filled with air while remaining attached to the valve stem of the tire.

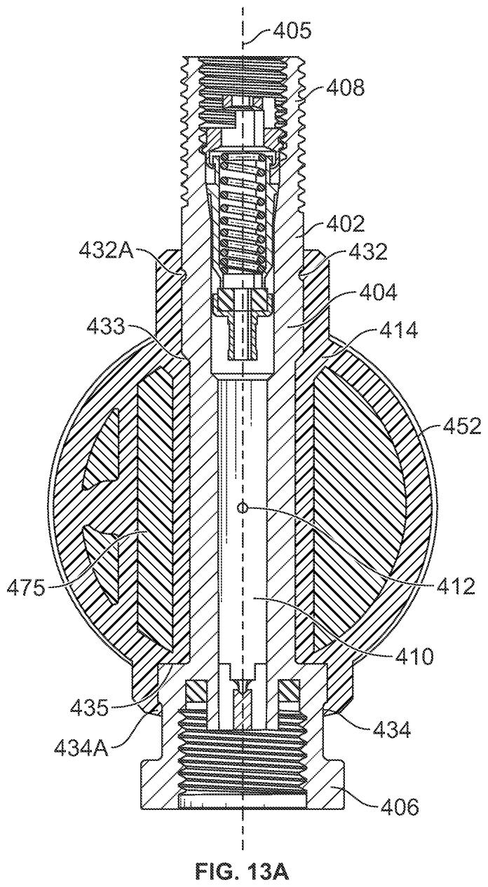

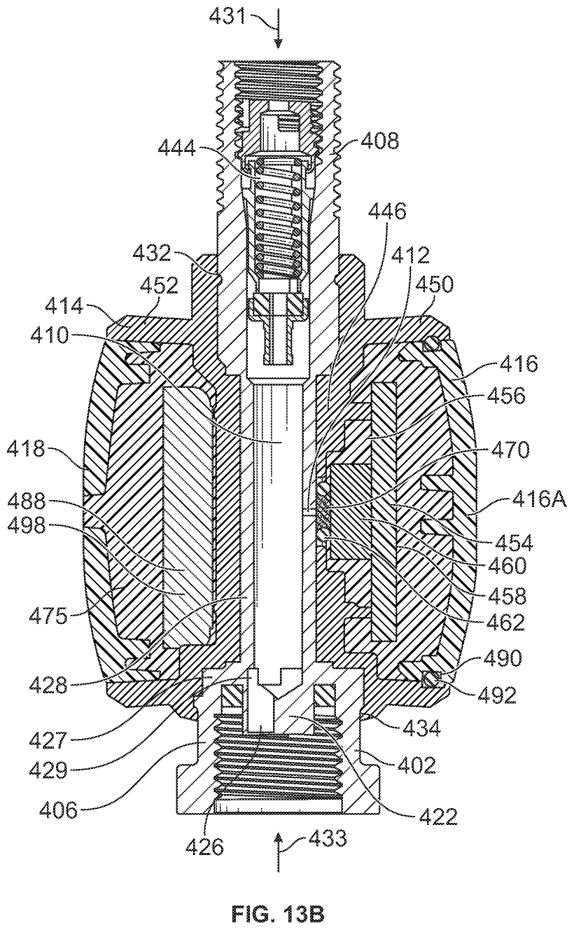

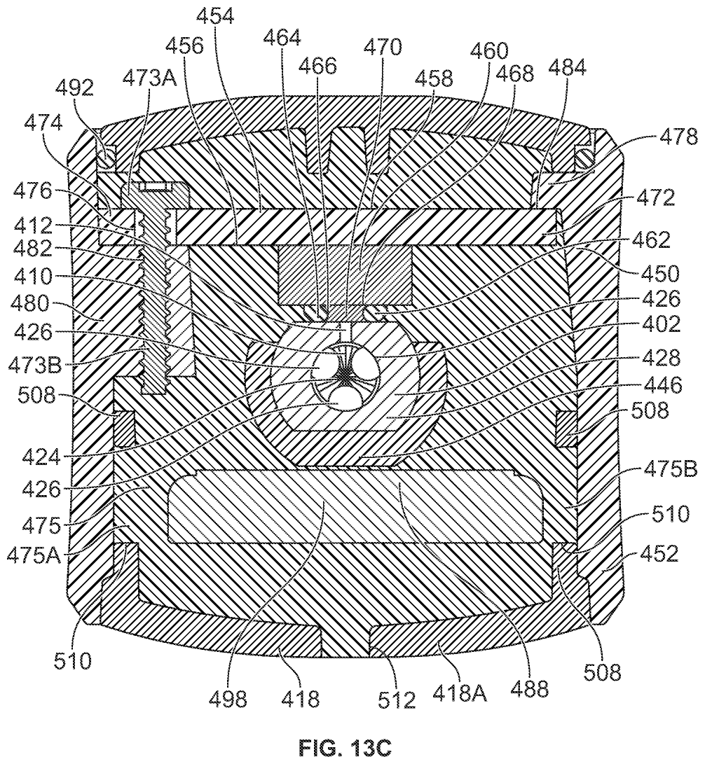

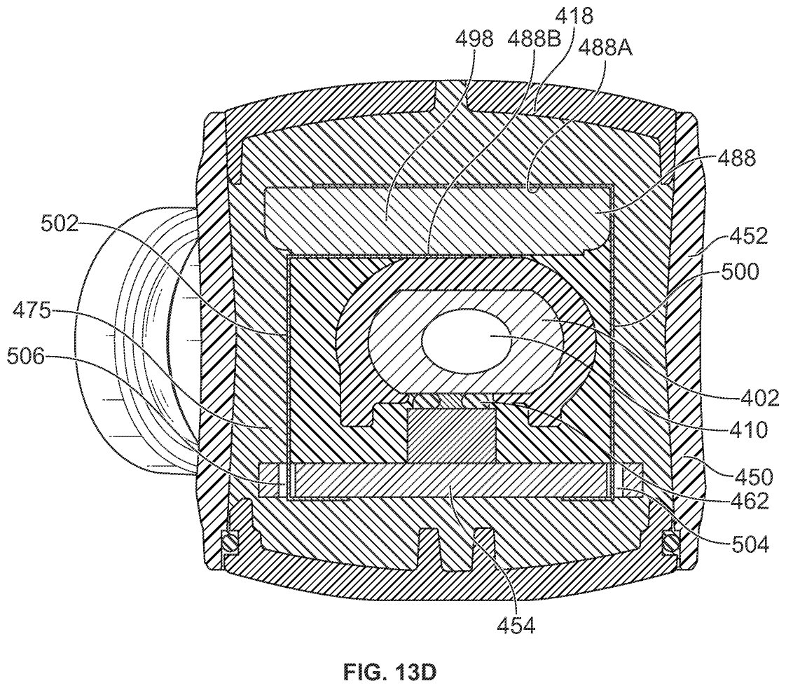

With reference to FIGS. 11, 12 and 15A-15B, the tire monitoring apparatus 400 includes a core, such as valve body 402, that extends through a central body 403. The central body 403 includes a housing 414 molded to the valve body 402, a first end cap 416, and a second end cap 418. Regarding FIG. 13A, the valve body 402 has tubular sidewall 404 extending about a central axis 405 from an attachment end portion 406 to a filling end portion 408. The sidewall 404 defines an interior 410 of the valve body 402 that forms a flow path or passageway for air to flow through the valve body 402. The valve body 402 includes an opening 412 in the sidewall 404 by which one or more variables (e.g., air pressure, temperature, humidity, or a combination thereof) of the tire are monitored by a sensor 460 as discussed below.

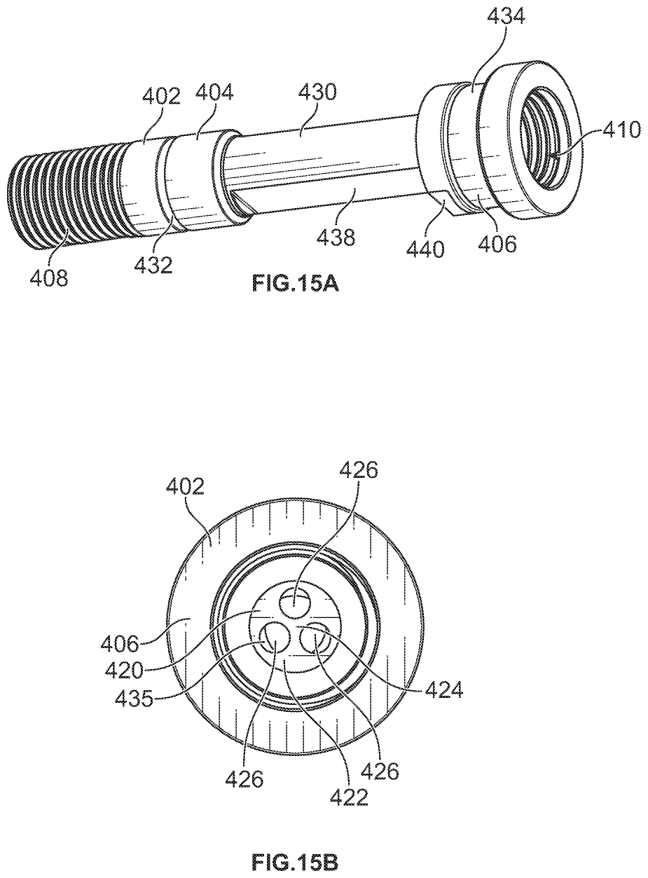

Regarding FIG. 15B, the attachment end portion 406 of the valve body 402 includes a valve actuator 420. The valve actuator 420 shifts a pin of a Schrader valve of the valve stem of the tire to open the valve as the attachment end portion 406 is attached to the valve stem. Attachment of the tire monitoring apparatus 400 to the valve stem of the tire thus opens the Schrader valve of the valve stem such that the interior 410 of the valve body 410 is fluidly coupled to the interior of the tire.

The valve actuator 420 includes an actuating member 422 extending across the interior 410 of the valve body 402. The actuating member 422 has a central portion 424 positioned to abut and shift the pin of the Schrader valve of the valve stem when the tire monitoring apparatus 400 is attached thereto. For instance, the central portion 424 may be aligned with the central axis 405 of the valve body 402 and/or be centrally aligned with the attachment end portion 406. Threading the attachment end portion 406 to the valve stem of the tire moves the central portion 424 axially relative to the valve stem to shift the pin of the Schrader valve of the valve stem and open the Schrader valve.

The actuating member 422 of the valve actuator 420 has through bores or openings 426 disposed about the central portion 424 of the actuating member 422 that extend axially through the actuating member 422. The openings 426 permit air to flow through the actuating member 422, for example, when a pressurized air source is attached to the filling end portion 408 of the tire monitoring apparatus 400 to fill the tire with air without removing the tire monitoring apparatus 400. Having the openings 426 extend axially through the actuating member 422 permits the air to flow straight through the openings 426 which reduces the pressure drop across the actuating member 422 and increases the air flow rate through the tire monitoring apparatus 400.

The actuating member 422 has three openings 426 spaced about the central portion 424 to increase the cross-sectional area of the flow path through the actuating member 422. The openings 426 are circular and have their centers spaced evenly 120 degrees apart around the central axis 405. The openings 246 define three spoke portions that extend radially inward and support the central portion 424. The spoke portions each have scalloped sides owing to the curvature of the openings 246.

Regarding FIG. 13B, the sidewall 404 has a narrow portion 428 extending from the filling end portion 408 to the attachment end portion 406 that has a narrower inner diameter than the attachment end portion 406. As shown in FIG. 13C, the pattern of openings 426 of the actuating member 422 about the central portion 424 may be larger than the inner diameter of the sidewall 404 at the narrow portion 428. In other words, a portion 429 (see FIG. 13B) of each of the three openings 426 is radially outward of the inner diameter of the narrow portion 428 and extends into a shoulder 427 of the sidewall 404. The pattern of openings 426 having these oversized diameters further increases the cross-sectional area of the flow path through the actuating member 422 and reduces of the pressure drop or resistance to air flow through the actuating member 422.

In one approach, valve body 402 is formed by milling the valve body 402 from a solid workpiece such as a rod. Regarding FIG. 13B, The interior 410 of the valve body 402 is formed at least in part by advancing a first drill tool from the filling end portion 408 in direction 431 until a conical leading end of the first drill tool reaches the shoulder 427. A second drill tool, offset radially from the center axis 405, is advanced from the attachment end portion 406 in an opposite direction 433 until a leading end of the second drill tool reaches the shoulder 427 to form each of the openings 426. The counter-boring of the interior 410 and the openings 426 creates an end surface 435 (see FIG. 15B) in the shoulder 427 at the end of each of the openings 426. As shown in FIG. 13B, the valve body 402 has a sleeve portion depending from the shoulder 427 and including female threads on an interior of the sleeve portion. The female threads extend about the actuator 422 which, at its upper base in FIG. 13B, has an annular channel of the valve body 402 extending thereabout. The valve body 402 has an o-ring, such as rubber or another elastomer, received in the annular channel to seal with a valve stem engaged with the female threads of the sleeve portion of the valve body 402.

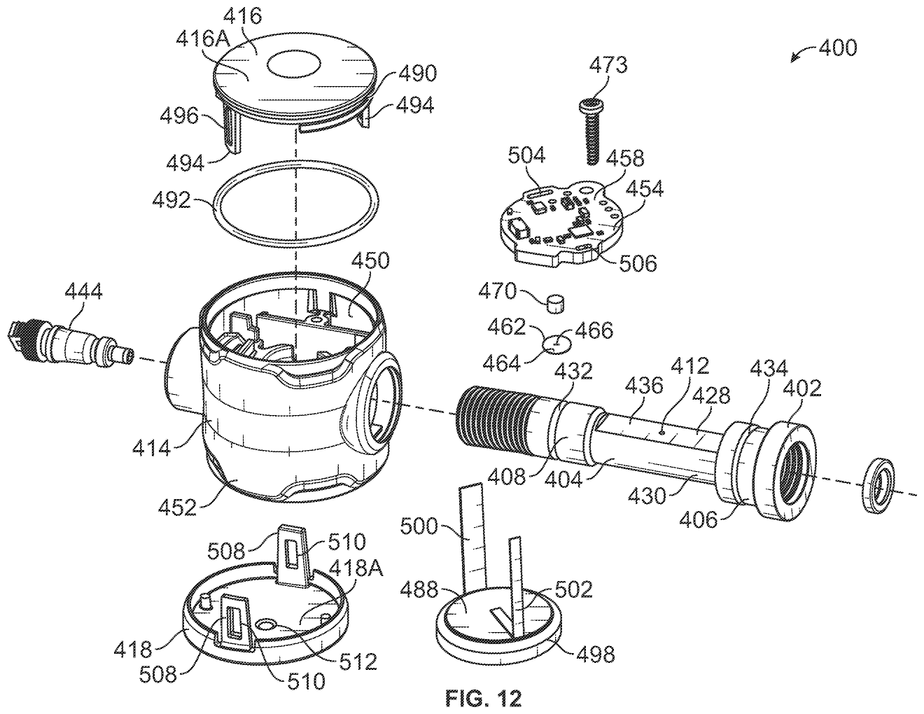

Regarding FIG. 15A, the valve body 402 has an exterior 430 that includes recesses 432, 434. The recesses 432, 434 are annular and extend about the valve body 402. As shown in FIG. 13A, the housing 414 is overmolded onto the valve body 402 which forms annular ribs 432A, 434A of the housing 414 that extend radially into the recesses 432, 434 and inhibits the housing 414 from moving axially relative to the valve body 402. Regarding FIG. 12, the exterior 430 of the narrow portion 428 of the valve body 402 is narrower than the attachment end portion 406 and/or filling end portion 408. The housing 414 is overmolded over the narrow portion 428 and exterior transition surfaces 433, 435 (see FIG. 13A) between the narrow portion 428, the attachment end portion 406, and filling end portion 408. The engagement between the interior surface portions of the housing 414 and exterior surface portions of the valve body 402 inhibits the housing 414 from moving axially relative to the valve body 402.

The tire monitoring apparatus 400 has engaging surface portions of the housing 414 and the valve body 402 that inhibit turning of the housing 414 about the valve body 402. More specifically and with reference to FIGS. 12 and 15A, the exterior 430 of the valve body 402 includes flats 436, 438 on opposite sides of the narrow portion 428 of the valve body 402. The exterior 430 may further include a flat 440 (see FIG. 15A) of the attachment end portion 406. The housing 414 is molded over the flats 436, 438, 440 which forms corresponding flats of the housing 414 that face and engage the flats 436, 438, 440 of the valve body 402 and inhibit the housing 414 from rotating relative to the valve body 402. The flats 436, 438, 440 may also aid to position the valve body 402 in a desired orientation in a mold used to overmold the housing 414 onto the valve body 402. Regarding FIG. 12, the opening 412 in the sidewall 404 of the valve body 402 extends through the flat 436 of the narrow portion 428. The flat 436 provides a flat surface for an O-ring 462 to seat against and form a fluid tight seal with the valve body 402 as discussed below.

The filling end portion 408 of the valve body 402 may include a valve core 444 similar to the embodiments discussed above that operates as a one-way valve to inhibit air from flowing out of the tire through the tire monitoring apparatus 400 while permitting the tire to be filled via pressurized air applied to the filling end portion 408. The valve core 444 may include, for example, a Schrader valve core.

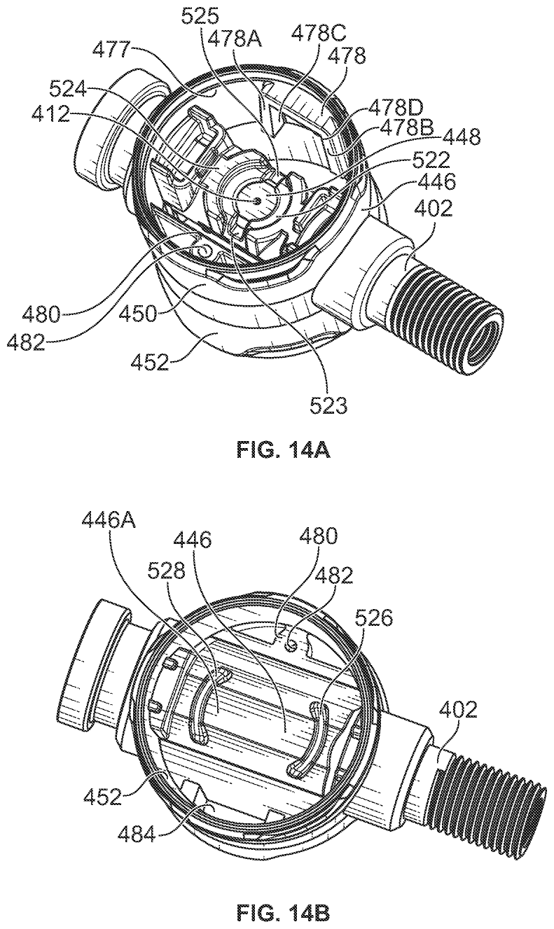

With respect to FIG. 11, the housing 414 is molded onto the valve body 402 to form an assembly of the housing 414, which may be made of plastic, and the tubular sidewall 404 of the valve body 402, which may be made of a metallic material such as brass. Regarding FIGS. 14A, 14B, the housing 414 includes a central portion 446 through which the valve body 402 extends. The central portion 446 has an opening 448 (see FIG. 14A) that opens to the opening 412 of the valve body 402. The housing 414 further includes a first portion 450 on one side of the valve body 402 and a second portion 452 on an opposite side the valve body 402. The housing 414 has a generally cylindrical outer profile that extends transversely to the valve body 402 between the first portion 450 and second portion 452. The first and second portions 450, 452 are radially outward of the valve body 402 and provide handle portions that a user may apply force to thread the tire monitoring apparatus 400 onto or off of a valve stem.

With respect to FIGS. 12 and 13B-13C, the tire monitoring apparatus 400 includes a circuit board 454 in the first portion 450 of the housing 414. The circuit board 454 has a first side 456 facing the valve body 402 and a second side 458 opposite the first side 456. The circuit board 454 has a sensor 460 mounted to the first side 456 and in fluid communication with the interior 410 of the valve body 402 via the opening 412 in the sidewall 404 of the valve body 402. The sensor 460 may be, for example, a temperature sensor, humidity sensor, and/or pressure sensor. A seal such as an O-ring 462 is positioned between the sensor 460 and the valve body 402. The O-ring 462 has a body 464 (see FIG. 12) extending about a central opening 466. The body 464 of the O-ring 462 extends about the opening 412 of the valve body 402 and a sensing portion 468 (see FIG. 13C) of the sensor 460. The sensing portion 468 of the sensor 460 is aligned with the central opening 466 of the O-ring 462 and the opening 412 of the valve body 402 such that air in the interior 410 of the valve body 402 acts upon the sensing portion 468 of the sensor 460.

Regarding FIG. 12, the tire monitoring apparatus 400 may include a membrane, such as a vapor barrier, between the sensor 460 and the interior 410 of the valve body 402. The membrane may be a plug 470 positioned in the central opening 466 of the O-ring 462 that permits air to flow therethrough while inhibiting water and/or debris from passing therethrough. The plug 470 have hydrophobic properties to resist water penetration and oleophobic properties to resist penetration from oils that are often present in air compressors. The plug 470 may be made, for example, of semi-permeable porous PTFE, for example, a Gore-Tex™ PTFE material. In other forms, the membrane is as discussed above with respect to the other embodiments. For example, the membrane may be positioned between the O-ring 462 and the valve body 402. As another example, the membrane may be positioned between the O-ring 462 and the sensor 460.

The circuit board 454 is secured to the housing 414 to urge the sensor 460 firmly against the O-ring 462 to compress the O-ring 462 between the sensor 460 and the valve body 402. Compressing the O-ring 462 between the valve body 402 and the sensor 460 operates to form a fluid tight seal between the O-ring 465 and the valve body 402 and between the O-ring 465 and the sensor 460. The O-ring 462 fluidically isolates the interior of the housing 414 from the interior 410 of the valve body 402. The O-ring 462 thus inhibits air, water, and debris in the interior 410 of the valve body 402 from flowing radially outward of the O-ring 462. The O-ring 462 also inhibits potting 475 poured into the housing 414 during manufacture of the tire monitoring apparatus 400 from flowing into the interior 410 of the valve body 402 or covering the sensing portion 468 of the sensor 460 as discussed in greater detail below. The sensor 460 may also compress the plug 470.

With reference to FIG. 13C, the circuit board 454 may be secured to the housing 414 with a hook and fastener connection that includes a fastener, such as screw 473. Other fasteners that my be used include one or more of a rivet, heat-staked pin, or barb. The circuit board 454 has a hook portion such as a tab 472 and a hook portion such as a fastener-receiving portion 474 opposite the tab 472 that includes an opening 476 for the screw 473. The housing 414 has a lip 478 extending radially inward into an interior 477 (see FIG. 14A) of the housing 414. The housing 414 also includes a support 480 extending inward into the housing 414 including an attachment opening 482. The tab 472 of the circuit board 454 is positioned adjacent an underside 484 of the lip 478. The fastener-receiving portion 474 of the circuit board 454 rests upon the support 480. The screw 473 extends through the opening 476 of the circuit board 454 and into the attachment opening 482 of the support 480. The screw 473 may be a self-tapping screw and creates threads in the support 480 as a shank 473B of the screw 473 is driven into the attachment opening 482. The circuit board 454 is secured in a final, installed position between the lip 478 of the housing 414 and head 473A of the screw 473 on the second side 458 of the circuit board 454 and the support 480 on the first side 456 of the circuit board 454. The overlapping housing lip 478 and circuit board tab 472 as well as the screw 473 and support 480 firmly secure the circuit board 454 to the housing 414 and keeps the sensor 460 compressing the o-ring 462 against the valve body 402. Further, the engagement between the overlapping housing lip 478 and circuit board tab 472 as well as the screw 473 and support 480 inhibit movement of the circuit board 454 when the housing 414 is filled with potting 475. Securing the circuit board 454 to the housing 414 with the screw 473, housing lip 478, and housing support 480 during assembly fixes the circuit board 454 in the final, installed position relative to the housing 414. Fixing the circuit board 454 to the housing 414 avoids the circuit board 454 moving after installation of a battery 498 and inhibits strain on connections between battery terminals 500, 502 of the battery 498 and the circuit board 454. Once the potting 475 is cured, the potting 475 further secures the circuit board 454 relative to the housing 414.

With respect to FIG. 14A, the housing 414 includes legs 478A, 478B that extend inward into the interior of the housing 414. The legs 478A, 478B extend from the lip 478 generally toward the second portion 452 of the housing 414. The legs 478A, 478B have inner side surfaces 478C, 478D to contact the circuit board tab 472 and resist turning of the circuit board 454 in the interior 477 of the housing 414. The housing 414 has support walls 522, 524 that the first side 456 of the circuit board 454 contacts. The support walls 522, 524 may limit movement of the circuit board 454 toward the valve body 402, for example, as the circuit board 454 is attached to the housing 414 to compress the O-ring 462, and maintain a spacing between the circuit board 454 and the valve body 402. The support walls 522, 524 also provide a flat surface for the circuit board 454 to engage to ensure the circuit board 454 is level when the circuit board 454 is secured in place with the screw 473. The support walls 522, 524 may be spaced apart by recesses 523, 525. The recesses 523, 525 permit air to escape from about the O-ring 462 as the housing 414 is filled with potting 475 during assembly of the tire monitoring apparatus 400.

With respect to FIG. 14B, the central portion 446 of the housing includes one or more battery supports such as ridges 526, 528 that the battery cell 488 seats against. The ridges 526, 528 space an underside of a battery cell 488 of the battery 498 from a surface 446A of the central portion 446 of the housing 414 so that potting can flow between the battery cell 488 and the surface 446A.

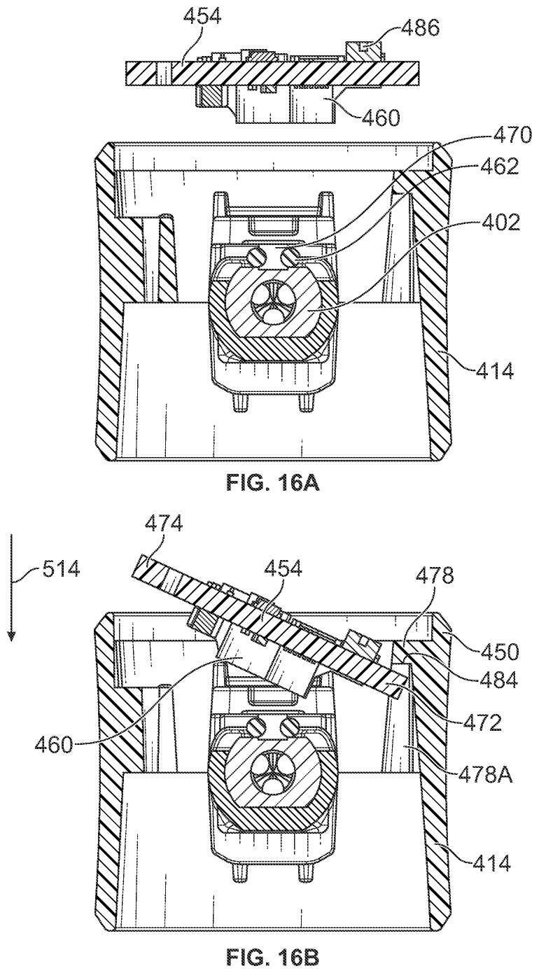

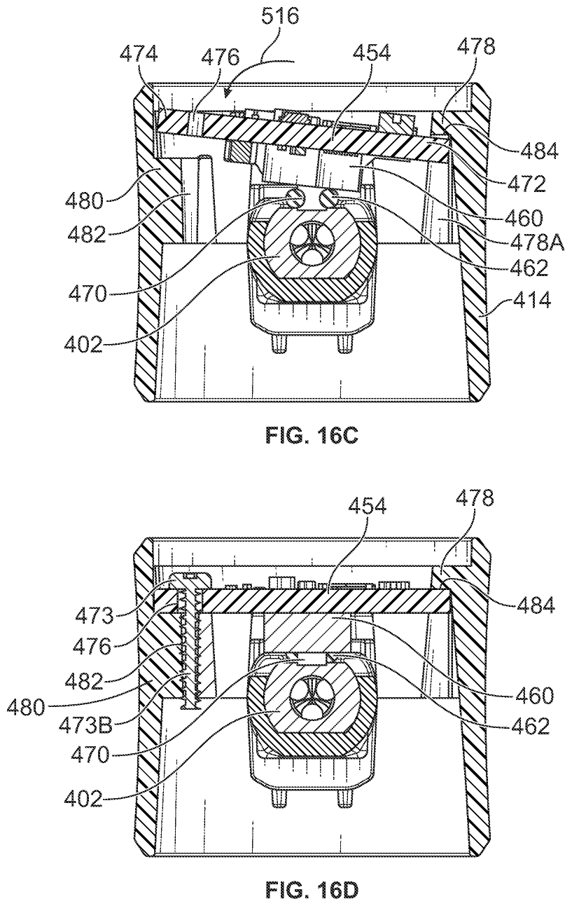

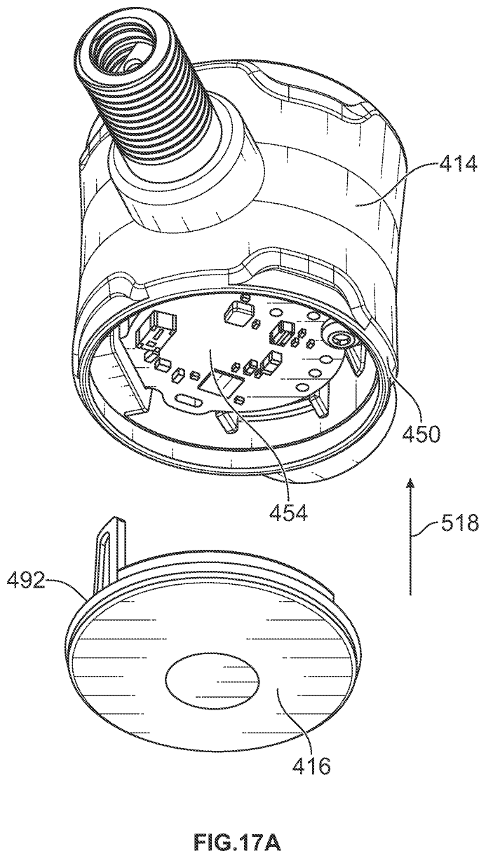

The circuit board 454 has communication circuitry 486 (see FIG. 16A) mounted to the second side 458 (see FIG. 13C) of the circuit board 454 facing away from the valve body 402. Positioning the communication circuitry 486 on the second side 458 of the circuit board 454 spaced apart from and facing away from the valve body 402 and the battery cell 488 in the second portion 452 of the housing 414 reduces communication signal interference caused by the valve body 402 and/or battery cell 488. The communication circuitry 486 may include an antenna or a plurality of antennae for communicating via radio frequency signals, such as surface mount chip antenna. As an example, the communication circuitry 486 may be configured to communicate via a Bluetooth wireless protocol.

With reference to FIGS. 12-13B, the end cap 416 has a body 416A that closes the first portion 450 of the housing 414. The end cap 416 includes an annular recess 490 (see FIG. 13B) that receives an O-ring 492. The O-ring 492 extends between the end cap 416 and the housing 414 to form a fluid tight seal therebetween. The end cap 416 and O-ring 492 may be configured to form an interference fit connection with the first portion 450 of the housing 414 to initially connect the end cap 416 to the housing 414. The end cap 416 may be connected to the housing 414 before pouring potting into the housing 414. The O-ring 492 resists potting from escaping from the connection between the end cap 416 and the housing 414.

The end cap 416 includes depending arms 494 that extend inward into the housing 414. The arms 494 are embedded in the potting 475 which secures the end cap 416 to the housing 414. Regarding FIG. 13C, the arms 494 include openings 496 and the potting 475 has portions that extend through the openings 496 to anchor the end cap 416 to the potting 475 and the housing 414.

With reference to FIGS. 12 and 13B-13D, the tire monitoring apparatus 400 includes the battery 498 having the battery cell 488 and electrical conductors such as the battery terminals 500, 502. The battery cell 488 is received in the second portion 452 of the housing 414 with the valve body 402 extending between the battery cell 488 and the circuit board 454. The battery terminal 500 is integral with or connected (e.g., soldered or welded) to a positive electrode 488A (see FIG. 13D) of the battery cell 488 and the battery terminal 502 is connected to a negative electrode 488B of the battery cell 488. The battery terminals 500, 502 extend from the battery cell 488 in the second portion 452 of the housing 414 to the circuit board 454 in the first portion 450 of the housing 414. The battery terminals 500, 502 extend from diametrically opposite side of the circular battery cell 488 such that the valve body 402 extends between the battery terminals 500, 502. The battery terminals 500, 502 are secured to the circuit board 454 to provide electrical power to the components of the circuit board 454. For example, the battery terminals 500, 502 may be soldered to the circuit board 454. The positive battery terminal 500 may have a greater width than the negative battery terminal 502 as shown in FIG. 12. The circuit board 454 includes a slot 504 for receiving the positive battery terminal 500 and a slot 506 for receiving the negative battery terminal 502. The slot 506 has a width sized to receive the negative battery terminal 502 but inhibit insertion of the positive battery terminal 500 therethrough to ensure the battery 498 is connected to the circuit board 454 properly during assembly. The potting poured into the housing 414 flows between the battery 498, the end cap 418, and the central portion 446 of the housing 414 to secure the battery 498 relative to the housing 414 and valve body 402.

With reference to FIG. 12, the end cap 418 has a body 418A that closes the second portion 452 of the housing 414. The end cap 418 may be inserted into the second portion 452 of the housing 414 after liquid potting has been poured into the housing 414. The end cap 418 may include arms 508 that extend inward into the housing 414. The arms 508 are embedded in the potting 475 (see FIG. 13C) which secures the end cap 418 to the housing 414. The arms 508 have openings 510 (see FIG. 12) and potting 475 has portions 475A, 475B (see FIG. 13C) that extend through the openings 510 to anchor the end cap 418 to the potting 475 and housing 414 once the potting 475 solidifies. The end cap 418 has an opening 512 in the body 418A through which air and/or excess liquid potting may escape from the housing 414 as the end cap 418 is inserted into the housing 414.

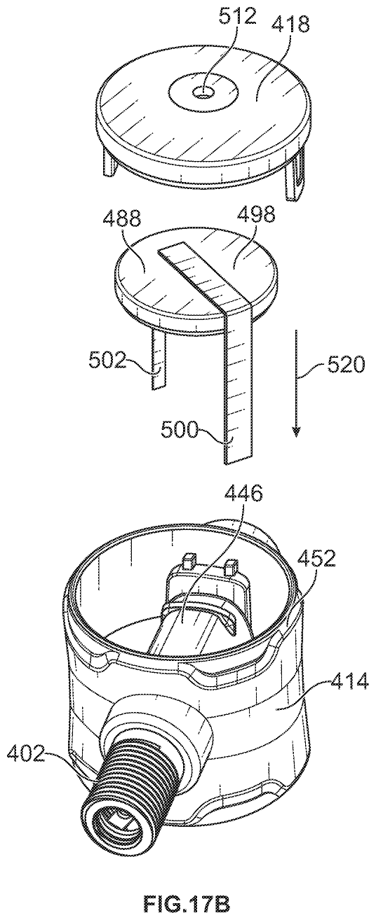

With respect to FIGS. 16A-17B, a method of assembling the tire monitoring apparatus 400 is provided. With reference to FIG. 16A, the circuit board 454 has the circuit components (e.g., the communication circuitry 486 and sensor 460) mounted thereto. The housing 414 is molded onto the valve body 402. For example, the valve body 402 is positioned in a mold and a plastic is advanced into the mold to form the housing 414 over the valve body 402.

Regarding FIG. 16A, the O-ring 462 and vapor barrier plug 470 are positioned on the valve body 402 with the vapor barrier plug 470 in the opening 466 of the O-ring 462. The opening 466 of the O-ring 462 is aligned with the opening 412 of the valve body 402. In another embodiment, the vapor barrier plug 470 is not used.

With respect to FIG. 16B, to position the circuit board 454 in the housing 414, the circuit board 454 is inclined and advanced generally in direction 514 to position the tab 472 of the circuit board 454 under the lip 478 of the housing 414.

With respect to FIG. 16C, the circuit board 454 is pivoted in direction 516 relative to the housing 414 to move the fastener-receiving portion 474 of the circuit board 454 into the housing 414 toward the support 480. Pivoting the circuit board 454 in direction 516 compresses the O-ring 462 between the sensor 460 and the valve body 402. The O-ring 462 resists being compressed and applies a reaction force against the circuit board 454 that urges the circuit board tab 472 against the underside 484 of the lip 478 of the housing 414. The circuit board 454 is continued to be pivoted in direction 516 until the fastener-receiving portion 454 seats against the support 480. Because the circuit board tab 472 is received in a recess 479 (see FIG. 14A) formed by the lip 478 and legs 478A, 478B, the legs 478A, 478B of the housing 414 constrain the circuit board 454 to pivotal movement as the circuit board 454 is pivoted in direction 516.

With respect to FIG. 16D, the opening 476 of the fastener-receiving portion 474 of the circuit board 454 is aligned with the attachment opening 482 of the housing 414 once the circuit board 454 has been fully pivoted downward in direction 516. The shank 473B of the screw 473 is advanced into the opening 476 of the circuit board 454 and is driven into the attachment opening 482 of the housing 414 to secure the circuit board 454 to the housing 414. Tightening down of the screw 473 fixes the circuit board 454 between the support 480 and the lip 478 of the housing 414 as well as positions the sensor 460 at a predetermined distance from the valve body 402 to compress the O-ring 462 a predetermined distance.

With respect to FIG. 17B, the battery 498 is connected to the circuit board 454 after the circuit board 454 is secured to the housing 414 using the screw 473 and before the end cap 416 is attached to the first portion 450 of the housing 414. The battery 498 is inserted into the second portion 452 of the housing in direction 520. The battery terminals 500, 502 of the battery 498 are extended through the respective slots 504, 506 of the circuit board 454. The battery 498 is inserted into the housing 414 until the battery cell 488 seat against ridges 526, 528 (see FIG. 14B). The battery terminals 500, 502 are soldered to respective contact pads of the circuit board 454 to provide electrical power to the circuit board 454. Connecting the battery 498 to the circuit board 454 before attaching the end cap 416 to the housing 414 permits an assembly worker to access the second side 458 of the circuit board 454 for soldering the battery terminals 500, 502. In another approach, the battery 498 may be connected to the circuit board 454 after the end cap 416 has been attached to the housing 414.

Regarding FIG. 17A, the end cap 416 is inserted in direction 518 into the first portion 450 of the housing 414 to attach the end cap 416 to the housing 414. The end cap 416 is inserted to close the first portion 450 of the housing 414. Insertion of the end cap 416 forms a interference fit connection between the end cap 416 and housing 414 and engages the O-ring 492 with the housing 414. The O-ring 492 forms a fluid tight connection between the end cap 416 and the housing 414.

Regarding FIG. 17B, after the battery 498 is attached to the circuit board 454 and the end cap 416 is attached to the housing 414 to close the open end of the first portion 450 of the housing 414, liquid potting is advanced (e.g., poured) into the housing 414 from the second portion 452 of the housing 414 generally in direction 520. The housing 414 may be filled with the liquid potting to cover the circuit board 454, battery 498, and arms 494 of the end cap 416 in the potting.

Upon filling the housing 414 with the liquid potting, the end cap 418 is inserted in direction 520 into the second portion 452 of the housing 414. The end cap 418 is inserted to close the second portion 452 of the housing 414. The arms 508 of the end cap 418 are inserted into and embedded in the liquid potting. Air and excess potting may escape from the housing 414 through the opening 512 of the end cap 418. The potting may fill the opening 512 of the end cap 418.

Upon closing the housing 414 with the end cap 418, the liquid potting is permitted to cure and harden which forms potting 475 of the tire monitoring apparatus 400. The potting 475 protects the internal components of the tire monitoring apparatus 400 and secures the end caps 416, 418, circuit board 454, and battery 498 to the housing 414.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A tire monitoring apparatus comprising:
a circuit board;
a battery;
a valve body intermediate the circuit board and the battery, the valve body having an attachment end portion for connecting to a valve stem of a tire, a filling end portion for receiving pressurized air, and an internal passageway to permit air to travel from the filling end portion to the attachment end portion;
a sensor of the circuit board configured to detect a variable of air in the internal passageway of the valve body;
communication circuitry of the circuit board operable to wirelessly communicate data associated with the variable of the air;
a support permanently encapsulating the circuit board and the battery about the valve body; and
the support comprising a structural member molded onto the valve body and an embedding member securing the circuit board and the battery to the structural member.

2. The tire monitoring apparatus of claim 1 wherein the embedding member comprises potting.

3. The tire monitoring apparatus of claim 1 wherein the circuit board is mounted to the structural member via a hook and fastener connection of the support.

4. The tire monitoring apparatus of claim 1 wherein the structural member comprises first and second recesses on opposite sides of the valve body;
wherein the battery is in the first recess;
wherein the circuit board is in the second recess; and
wherein the embedding member is in the first recess and the second recess to secure the battery and the circuit board in the first and second recesses.

5. The tire monitoring apparatus of claim 1 further comprising a sealing member extending about the sensor; and
the sealing member is engaged with the circuit board and at least one of the structural member and the valve body.

6. The tire monitoring apparatus of claim 1 wherein the valve body includes a side wall having a through opening therein;
wherein the sensor includes a sensing portion adjacent the through opening; and
an o-ring extending about the through opening and the sensing portion, the o-ring compressed between the sensor and the valve body.

7. The tire monitoring apparatus of claim 1 wherein the circuit board comprises openings; and
wherein the battery comprises a battery cell and terminals extending on either side of the valve body from the battery cell into the openings of the circuit board.

8. The tire monitoring apparatus of claim 7 wherein the terminals of the battery have different widths; and
wherein the openings of the circuit board have different widths.

9. The tire monitoring apparatus of claim 1 wherein the structural member is a housing;
wherein the embedding member comprises potting in the housing; and
wherein the support comprises caps connected to the housing on opposite sides of the valve body.

10. The tire monitoring apparatus of claim 1 wherein the support comprises a cap connected to the structural member, the cap having an opening; and
wherein a portion of the embedding member is in the opening.

11. The tire monitoring apparatus of claim 1 wherein the structural member includes a housing having upper and lower openings;
wherein the embedding member includes at least a portion thereof in the housing;
wherein the support includes upper and lower caps covering the upper and lower openings of the housing;
wherein the caps include arms with openings; and
wherein the embedding member includes anchor portions extending in the openings of the arms of the caps to connect the caps and the housing.

12. The tire monitoring apparatus of claim 1 wherein the battery is embedded in the embedding member.

13. The tire monitoring apparatus of claim 1 wherein the structural member is an inner support and the embedding member is an outer body molded over the inner support.

14. The tire monitoring apparatus of claim 1 wherein the valve body comprises:
a tubular wall extending about the internal passageway; and
a valve core supported by the tubular wall.

15. A method of manufacturing a tire monitoring apparatus, the method comprising:
molding a first material onto a valve body to form a first portion of a support, the valve body having an attachment end portion for connecting to a valve stem of a tire and a filling end portion for receiving pressurized air;
positioning a battery and a circuit board proximate the first portion of the support on opposite sides of the valve body, the circuit board including a sensor to detect a variable of air in the valve body; and
advancing a second material into contact with the first portion of the support to form a second portion of the support connected to the first portion of the support, the first and second portions of the support securing the battery and the circuit board to the valve body.

16. The method of claim 15 wherein advancing the second material into contact with the first portion of the support comprises advancing potting into contact with the first portion of the support.

17. The method of claim 15 wherein positioning the battery and the circuit board proximate the first portion of the support comprises compressing a seal member between the circuit board and at least one of the first portion of the support and the valve body.

18. The method of claim 15 wherein positioning the battery and the circuit board of the support proximate the first portion of the support comprises advancing the battery and the circuit board into first and second openings of the first portion of the support on opposite sides of the first portion of the support; and
wherein advancing the second material into contact with the first portion of the support to form the second portion of the support comprises advancing the second material into the first and second openings.

19. The method of claim 15 wherein molding the first material onto the valve body to form the first portion of the support comprises molding the first material to form a housing;
wherein positioning the battery and the circuit board proximate the first portion of the support comprises positioning the battery and the circuit board in an interior of the housing; and
wherein advancing the second material into contact with the first portion of the support comprises advancing the second material into the housing.

20. The method of claim 15 wherein positioning the battery and a circuit board proximate the first portion of the support comprises engaging a hook and screw connection.

21. The method of claim 15 wherein positioning the battery and the circuit board proximate the first portion of the support comprises:
positioning a tab of the circuit board below a lip of the first portion of the support;
pivoting a fastener receiving portion of the circuit board downward toward a support surface of the first portion of the support; and
advancing a portion of a fastener through an opening of the fastener receiving portion of the circuit board and into an opening of the first portion of the support to secure the circuit board to the first portion of the support.

22. The method of claim 15 further comprising connecting a cap to the first portion of the support; and
wherein advancing the second material into contact with the first portion of the support comprises advancing a portion of the second material into an opening of the cap.

23. The method of claim 15 wherein positioning the battery and the circuit board comprises advancing leading end portions of terminals of the battery on opposite sides of the valve body and into openings of the circuit board.

24. The method of claim 15 wherein molding the first material onto the valve body to form the first portion of the support comprises molding the first material onto flats of the valve body to form non-rotatable connections between the first portion of the support and the valve body.

25. The method of claim 15 wherein advancing the second material into contact with the first portion of the support comprises molding the second material onto the first material.

26. A tire monitoring apparatus comprising:
a metallic fitting having threads to engage threads of a valve stem of a tire;
a through opening in the metallic fitting;
a circuit board having a sensor with a sensing portion configured to detect a variable of air received via the through opening in the metallic fitting;
a sealing member between the circuit board and the metallic fitting, the sealing member forming a seal about the sensing portion of the sensor; and
a support connecting the circuit board to the metallic fitting, the support maintaining the circuit board at a predetermined distance from the metallic fitting to compress the sealing member and maintain the seal.

27. The tire monitoring apparatus of claim 26 wherein the sealing member comprises an o-ring; and
wherein the o-ring is sandwiched between the sensor and the metallic fitting.

28. The tire monitoring apparatus of claim 26 further comprising a water-resistant membrane protecting the sensing portion of the sensor.

29. The tire monitoring apparatus of claim 26 wherein the support comprises a housing mounted to the metallic fitting and potting fixing the circuit board and housing together.

30. The tire monitoring apparatus of claim 26 wherein the support and circuit board have a hook-and-screw connection therebetween.

31. The tire monitoring apparatus of claim 26 wherein the circuit board has a first side with the sensor thereon and a second side opposite the first side; and
wherein the support includes support surfaces engaged with the second side of the circuit board.

32. The tire monitoring apparatus of claim 31 wherein the support comprises a structural member of a first material mounted to the metallic fitting and a screw; and
wherein the structural member and the screw include the support surfaces.

33. The tire monitoring apparatus of claim 26 wherein the support comprises a housing having a lip and a support portion spaced across an interior of the housing from the lip; and
wherein the circuit board is the interior of the housing; and
wherein the lip and support portion of the housing engage opposite sides of the circuit board.

34. The tire monitoring apparatus of claim 26 wherein the metallic fitting comprises a filling end portion, an attachment end portion, and a tubular side wall extending therebetween along a central axis; and
wherein the through opening extends through the tubular side wall transverse to the central axis.

35. The tire monitoring apparatus of claim 26 further comprising a battery;
wherein the support connects the circuit board to the metallic fitting; and
wherein the circuit board includes communication circuitry operable to wirelessly communicate data associated with the variable to a remote device.

36. The tire monitoring apparatus of claim 26 wherein the support includes a structural member mounted to the valve body, the structural member having a portion thereof between the sealing member and the metallic fitting; and
wherein the sealing member is sandwiched between the circuit board and the portion of the structural member.

37. The tire monitoring apparatus of claim 26 wherein the fitting is a valve cap.

38. A tire monitoring apparatus comprising:
a valve body having a central, longitudinal axis;
an attachment end portion of the valve body configured to be engaged with a valve stem of a tire;
a filling end portion of the valve body configured to receive compressed air;
a central body connected to the valve body, the central body comprising a sensor to detect a variable of air in the valve body, a battery, and communication circuitry operable to wirelessly communicate data associated with the variable;
an actuator of the attachment end portion having a central portion intersected by the central, longitudinal axis and configured to open a valve of the valve stem upon the attachment end portion being connected to the valve stem;
three axial through openings of the actuator radially offset from the central, longitudinal axis and spaced thereabout to permit air to pass through the actuator; and
three spoke portions of the actuator supporting the central portion of the actuator in the attachment end portion of the valve body, the three spoke portions defined at least in part by the three axial through openings of the actuator.

39. The tire monitoring apparatus of claim 38, wherein the valve body has a narrow portion intermediate the filling end portion and the actuator, the narrow portion having an internal passageway and a cylindrical surface extending thereabout, the cylindrical surface being a first radial distance from the central longitudinal axis; and
wherein at least a portion of each of the three axial through openings are radially outward of the central, longitudinal axis a second radial distance that is greater than the first radial distance.

40. The tire monitoring apparatus of claim 38 wherein the attachment end portion of the valve body includes a shoulder;
wherein the valve body includes a narrow portion extending from the shoulder toward the filling end portion, the narrow portion including an air passageway; and
wherein at least a portion of each of the three axial through openings is formed in the shoulder of the valve body.

41. The tire monitoring apparatus of claim 38 wherein the attachment end portion comprises:
a sleeve portion having female threads;
an annular channel extending about the actuator; and
an o-ring in the annular channel.
